(19) United States
(12) Patent Application Publication
(10) Pub. No.: US 2017/0034237 A1
(43) Pub. Date: Feb. 2, 2017

(54) Interactive Content Streaming Over Live Media Content

(71) Applicant: Giga Entertainment Media Inc., Walnut Creek, CA (US)

(72) Inventor: Lawrence Way Silver, Walnut Creek, CA (US)

(73) Assignee: Giga Entertainment Media Inc.

(21) Appl. No.: 15/220,413

(22) Filed: Jul. 27, 2016

Related U.S. Application Data
(60) Provisional application No. 62/197,578, filed on Jul. 28, 2015.

(51) Int. Cl. H04L 29/06; G11B 27/036; H04N 21/8545; H04N 21/44; H04N 21/431; H04N 21/43; H04N 21/475; H04N 5/272; H04N 21/858

(52) U.S. Cl. CPC H04L 65/604; H04N 5/272; G11B 27/036; H04N 21/8545; H04N 21/858; H04N 21/4316; H04N 21/4307; H04N 21/4758; H04N 21/44004; H04L 65/4069; G06F 3/0482

(57) ABSTRACT

A computer implemented method and an interactive content overlay and streaming system (ICOSS) for overlaying user media content (UMC) on content data streams (CDSs) and synchronizing the CDSs in real time with the UMC are provided. The ICOSS renders an interactive space editor with content panels on a graphical user interface on a user device. The ICOSS receives a selection of the CDSs and records the UMC while streaming the selected CDSs. The ICOSS records content panel events and synchronization data and generates a content media object. When viewer devices access the content media object, the ICOSS overlays the UMC and an interaction panel on the CDSs. The ICOSS streams the CDSs and the overlaid UMC, and displays comments entered in the interaction panel from the viewer devices. The ICOSS synchronizes the CDSs being streamed in real time with the UMC using the content panel events and the synchronization data.

### CROSS-REFERENCE TO RELATED APPLICATIONS

This application claims priority to and the benefit of the provisional patent application No. 62/197,578 titled “Interactive Content Streaming Over Live Media Content”, filed in the United States Patent and Trademark Office on Jul. 28, 2015. The specification of the above referenced patent application is incorporated herein by reference in its entirety.

### BACKGROUND

To overlay media content on other media content, conventional methods multiplex the two sources of media content through a multiplexer device using analog methods to output one signal. There is a need for overlaying digital signals comprising media content. Other conventional methods perform detailed post processing to overlay one media content, for example, a video, onto another media content to obtain picture-in-picture videos. These conventional methods require a user to create reaction videos, that is, videos that capture reactions of the user to media content, and overlay the reaction videos on the media content, through a time consuming process. Moreover, the post processing performed to overlay a reaction video on the media content requires the use of expensive licensed software, extraction of the media content from a source of the media content, uploading of the reaction video and the media content to a server on a computer network, for example, the internet, etc. There is a need for streamlining the creation and sharing of reaction videos without requiring additional software tools. Moreover, there is a need for streaming media content with an overlay of other media content in real time. Furthermore, there is a need for synchronizing the media content being streamed with the media content being overlaid in real time. Furthermore, there is a need for recording media content and overlaying the recorded media content on streaming media content without altering the media content being streamed.

Users who consume media content on user devices often share opinions and comments on the media content with other users who can access the same media content. For example, users who view videos from various sources on the internet comment and discuss videos previously viewed or videos being viewed with other users who have accessed the videos. These users share comments and opinions predominantly using text in a graphical user interface (GUI) on their user devices in an area of the GUI that is physically separate from an area of the GUI used to display the media content being viewed. There is a need for overlaying a virtual component on the media content being viewed on the GUI of each of the user devices for rendering comments of users viewing the media content in real time through the media content without altering the media content being viewed.

Therefore, there is a long felt need for a computer implemented method and system that overlays user media content on content data streams and synchronizes the content data streams in real time with the overlaid user media content. Moreover, there is a need for a computer implemented method and system that overlays digital signals comprising media content. Furthermore, there is a need for a computer implemented method and system that streamlines the creation and sharing of reaction media content, for example, reaction videos, without requiring additional software tools. Furthermore, there is a need for a computer implemented method and system that streams content data streams with an overlay of user media content in real time. Furthermore, there is a need for a computer implemented method and system that synchronizes the content data streams being streamed with the user media content being overlaid in real time. Furthermore, there is a need for a computer implemented method and system that records user media content and overlays the recorded user media content on content data streams being streamed without altering the content data streams being streamed. Furthermore, there is a need for a computer implemented method and system that overlays a virtual component on media content being viewed on graphical user interfaces of user devices for rendering comments of users viewing the media content in real time through the media content without altering the media content being viewed.

### SUMMARY OF THE INVENTION

This summary is provided to introduce a selection of concepts in a simplified form that are further disclosed in the detailed description of the invention. This summary is not intended to determine the scope of the claimed subject matter.

The computer implemented method and system disclosed herein addresses the above recited need for overlaying user media content on content data streams and synchronizing the content data streams in real time with the overlaid user media content. Moreover, the computer implemented method and system disclosed herein overlays digital signals comprising media content. Furthermore, the computer implemented method and system disclosed herein streamlines the creation and sharing of reaction media content, for example, reaction videos, without requiring additional software tools. Furthermore, the computer implemented method and system disclosed herein streams content data streams with an overlay of user media content in real time. Furthermore, the computer implemented method and system disclosed herein synchronizes the content data streams being streamed with the user media content being overlaid in real time. Furthermore, the computer implemented method and system disclosed herein records user media content and overlays the recorded user media content on content data streams being streamed without altering the content data streams being streamed. The computer implemented method and system disclosed herein therefore allows any user with a user device to digitally place himself or herself into a layered picture-in-picture environment without altering source content. Furthermore, the computer implemented method and system disclosed herein overlays a virtual component on media content being viewed on graphical user interfaces (GUIs) of user devices for rendering comments of users viewing the media content in real time through the media content without altering the media content being viewed.

The computer implemented method disclosed herein employs an interactive content overlay and streaming system (ICOSS) comprising at least one processor configured to execute computer program instructions for overlaying user media content on content data streams and synchronizing the content data streams in real time with the overlaid user media content. The ICOSS renders an interactive space editor with multiple content panels on a graphical user interface (GUI) deployed on a user device. The content panels comprise links to the content data streams from multiple content sources. The ICOSS receives a selection of one or more of the content data streams to be rendered on the content panels of the interactive space editor from the user device. When the ICOSS receives a request to record the user media content from the user device, the ICOSS records the user media content on the user device using a media and event recorder of the user device while streaming the selected content data streams on the GUI. The ICOSS dynamically receives the user media content being recorded from the user device. The ICOSS overlays the user media content being recorded on the selected content data streams being streamed and records content panel events and synchronization data on the user device during the recording of the user media content. When the ICOSS receives a request for terminating the recording of the user media content from the user device, the ICOSS receives the recorded user media content, the recorded content panel events, and the recorded synchronization data from the user device.

The interactive content overlay and streaming system (ICOSS) generates a content media object by processing the received user media content for providing access of the processed user media content and the selected content data streams through the generated content media object to viewer devices. When the generated media content object is accessed by the viewer devices via the graphical user interface (GUI) deployed on each of the viewer devices, the ICOSS overlays the processed user media content and an interaction panel on the selected content data streams on the GUI deployed on each of the viewer devices. The ICOSS streams the selected content data streams with the overlaid user media content and displays comments entered in the interaction panel from the viewer devices via the GUI deployed on each of the viewer devices. The ICOSS synchronizes the selected content data streams being streamed in real time with the overlaid user media content being streamed using the received content panel events and the received synchronization data.

In one or more embodiments, related systems comprise circuitry and/or programming for effecting the methods disclosed herein; the circuitry and/or programming can be any combination of hardware, software, and/or firmware configured to effect the methods disclosed herein depending upon the design choices of a system designer. Also, various structural elements can be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1A illustrates a computer implemented method for overlaying user media content on content data streams and synchronizing the content data streams in real time with the overlaid user media content.

FIG. 1B exemplarily illustrates an embodiment where the computer implemented method overlays user media content on live content data streams and synchronizes the live content data streams in real time with the overlaid user media content.

FIG. 2 exemplarily illustrates a flow diagram comprising the steps performed by an interactive content overlay and streaming system for recording user media content and content panel events and generating a content media object for playback of the recorded user media content on a content data stream.

FIG. 3 exemplarily illustrates a flow diagram comprising the steps performed by the interactive content overlay and streaming system for overlaying processed user media content and an interaction panel on content data streams on a graphical user interface provided by the interactive content overlay and streaming system on viewer devices and synchronizing the content data streams in real time with the overlaid user media content.

FIG. 4 exemplarily illustrates a flowchart for recording and playback of user media content as an overlay on a content data stream on a user device.

FIG. 5 exemplarily illustrates an implementation of the interactive content overlay and streaming system, showing communication between modules of the interactive content overlay and streaming system for overlaying user media content on content data streams and synchronizing the content data streams in real time with the overlaid user media content.

FIG. 6 exemplarily illustrates a computer implemented system for overlaying user media content on content data streams and synchronizing the content data streams in real time with the overlaid user media content.

FIGS. 7A-7B exemplarily illustrate screenshots of a graphical user interface provided by an interactive content overlay and streaming application installed on a user device for accessing the interactive content overlay and streaming system.

FIG. 7C exemplarily illustrates a screenshot of the graphical user interface provided by the interactive content overlay and streaming application installed on the user device for selecting content data streams.

FIG. 7D exemplarily illustrates a screenshot of the graphical user interface provided by the interactive content overlay and streaming application installed on the user device, showing user media content being recorded, overlaid on a selected content data stream being streamed.

FIGS. 7E-7G exemplarily illustrate screenshots of the graphical user interface provided by the interactive content overlay and streaming application installed on the user device, showing the user media content being recorded, overlaid on a selected content data stream in a content panel, and content panel events being recorded during the recording of the user media content.

FIG. 7H exemplarily illustrates a screenshot of the graphical user interface provided by the interactive content overlay and streaming application installed on a viewer device for accessing a content media object generated by the interactive content overlay and streaming system.

FIG. 7I exemplarily illustrates a screenshot of the graphical user interface provided by the interactive content overlay and streaming application installed on the viewer device, showing processed user media content and an interaction panel overlaid on a selected content data stream in a content panel.

FIG. 8 exemplarily illustrates a screenshot of the graphical user interface provided by the interactive content overlay and streaming application installed on a viewer device, showing processed user media content and an interaction panel overlaid on different content data streams in content panels.

FIGS. 9A-9B exemplarily illustrate screenshots of the graphical user interface provided by the interactive content overlay and streaming application installed on a smartphone and a tablet computing device respectively, in a landscape orientation, showing user media content being recorded, overlaid on selected content data streams in content panels arranged in a first layout.

FIGS. 10A-10B exemplarily illustrate screenshots of the graphical user interface provided by the interactive content overlay and streaming application installed on a smartphone and a tablet computing device respectively, in a portrait orientation, showing the user media content being recorded, overlaid on selected content data streams in content panels arranged in a second layout.

FIGS. 11A-11B exemplarily illustrate screenshots of the graphical user interface provided by the interactive content overlay and streaming application installed on a smartphone and a tablet computing device respectively, in a landscape orientation, showing processed user media content and an interaction panel overlaid on selected content data streams in content panels arranged in a third layout.

FIGS. 12A-12B exemplarily illustrate screenshots of the graphical user interface provided by the interactive content overlay and streaming application installed on a smartphone and a tablet computing device respectively, in a portrait orientation, showing processed user media content and an interaction panel overlaid on selected content data streams in content panels arranged in a fourth layout.

### DETAILED DESCRIPTION OF THE INVENTION

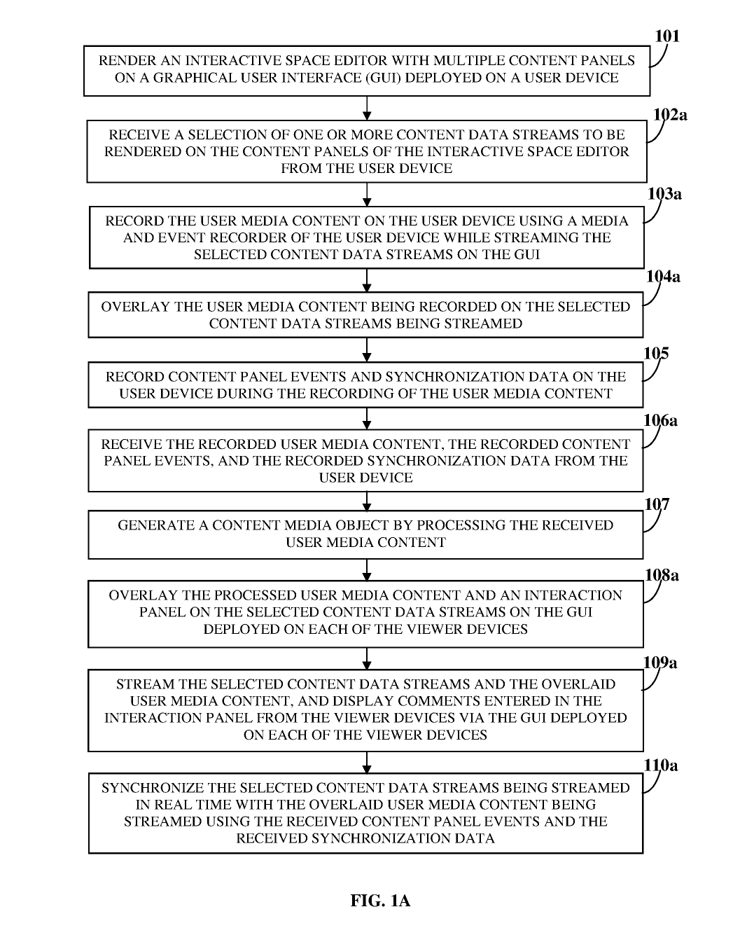

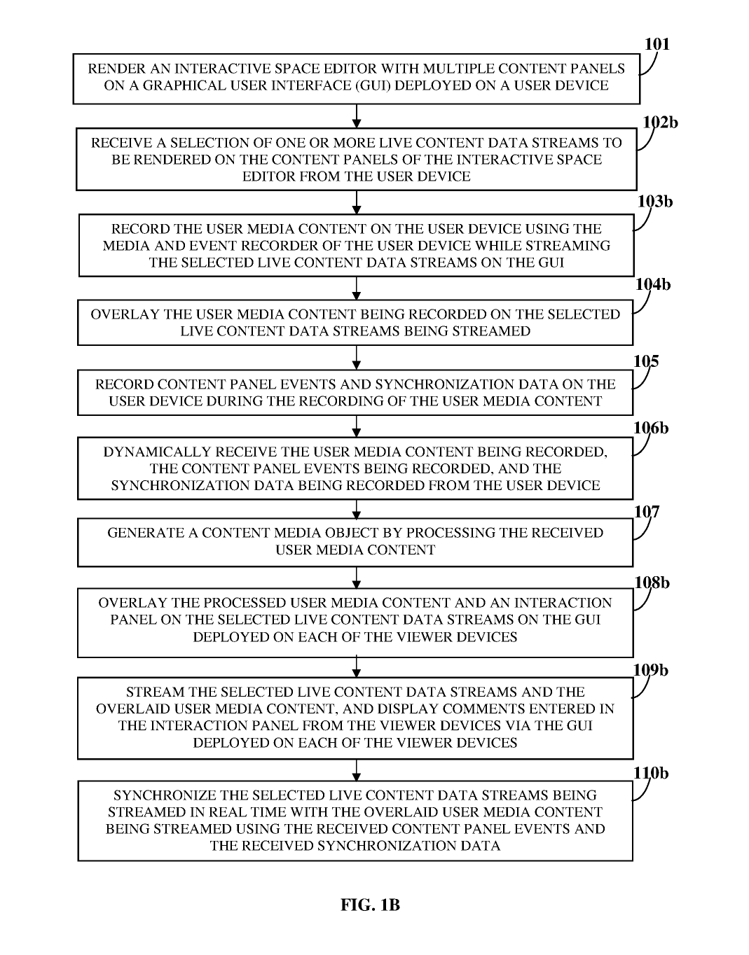

FIG. 1A illustrates a computer implemented method for overlaying user media content on content data streams and synchronizing the content data streams in real time with the overlaid user media content. As used herein, “user media content” refers to content recorded on a user device in different combined and individual formats, for example, textual content, audio content, image content, video content, audiovisual content, multimedia content, etc. Also, as used herein, “content data streams” refer to content streamed or loaded from different content sources. The content data streams comprise, for example, videos, webpages, video chat content, video conferencing content, gaming content, web browsing content, video-on-demand content, social media networking content, canned video content, user generated content, message content, electronic mail (email) content, audio content, audiovisual content, augmented reality content, three-dimensional media content, electronic commerce content, information, multimedia content, etc., and any combination thereof. Also, as used herein, “content sources” refer to repositories of content readily available, for example, on servers, user devices, storage devices, etc.

The computer implemented method disclosed herein employs an interactive content overlay and streaming system (ICOSS) comprising at least one processor configured to execute computer program instructions for overlaying user media content on content data streams and synchronizing the content data streams in real time with the overlaid user media content. In an embodiment, the ICOSS is configured as a web based platform, for example, a website hosted on a server or a network of servers. In another embodiment, the ICOSS is implemented in a client-server architecture comprising an interactive content overlay and streaming application (ICOSA) and a content overlay and streaming server (COSS). The ICOSA is a software application downloadable and usable on a user device and viewer devices. As used herein, “user device” and “viewer device” refer to electronic devices, each comprising a display unit and a processor. In another embodiment, the ICOSS is implemented in a cloud computing environment and provides an open communication community service. As used herein, “cloud computing environment” refers to a processing environment comprising configurable computing physical and logical resources, for example, networks, servers, storage, applications, services, etc., and data distributed over a network, for example, the internet. The cloud computing environment provides on-demand network access to a shared pool of the configurable computing physical and logical resources. The ICOSA is developed, for example, using Amazon Web Services® of Amazon Technologies, Inc., the Amazon elastic compute cloud EC2® web service of Amazon Technologies, Inc., etc. In an embodiment, the ICOSA is configured as a cloud computing based platform implemented as a service for overlaying user media content on content data streams and synchronizing the content data streams in real time with the overlaid user media content.

In an embodiment, the interactive content overlay and streaming system (ICOSS) comprises the interactive content overlay and streaming application (ICOSA) deployed on the user device, and the content overlay and streaming server (COSS) in communication with the ICOSA over a network, for example, the internet, an intranet, a wired network, a wireless network, a mobile telecommunication network, etc. For purposes of illustration, the detailed description refers to the ICOSS implemented in a client-server architecture; however the scope of the computer implemented method and system disclosed herein is not limited to the ICOSS implemented in a client-server architecture, but may be extended to be implemented entirely on a client system, or on a server system, or in a cloud computing environment. The ICOSS is configured to record the user media content and distribute the recorded user media content and the content data streams of different content formats to one or more computing devices of other users in real time. The content formats comprise, for example, a webpage format, a video format, etc. The ICOSS is configured to provide a graphical user interface accessible by each of the computing devices via a network.

The interactive content overlay and streaming application (ICOSA) renders 101 an interactive space editor with multiple content panels on the graphical user interface (GUI) deployed on a user device. As used herein, “interactive space editor” refers to a section of the GUI provided by the ICOSA that allows a user of the user device to arrange multiple content data streams in a desired layout on the display unit of the user device by editing a space on the section of the GUI. Also, as used herein, “content panel” refers to a container implemented in the GUI for accommodating a content data stream in the interactive space editor. The content panels comprise links to the content data streams from multiple content sources, for example, broadcast networks, content delivery networks, media sharing platforms comprising video sharing websites such as YouTube® of Google Inc., available on the internet, web platforms, etc. When a link to a content data stream is selected by a user of the user device, the ICOSS retrieves the content data stream from a content source and fills the content panel with the content data stream referred to by the link. The content overlay and streaming server (COSS) renders a list of content data streams, for example, as a curated library of videos for selection by the user via the GUI provided by the ICOSA on the user device. The user can also search for a video through a search option provided by the ICOSA on the GUI. The content overlay and streaming server (COSS) receives 102a a selection of one or more of the content data streams to be rendered on the content panels of the interactive space editor from the user device via the ICOSA installed on the user device.

When a user invokes the interactive content overlay and streaming application (ICOSA) on the user device, the ICOSA renders the interactive space editor with the content panels on the graphical user interface (GUI). The interactive space editor provides multiple options of content data streams over which the user can record the user media content. For example, a content data stream is a video from a curated library or a video from a content source on a network. In an embodiment, the GUI provides a search box for entering keywords used to search through available content data streams in different content sources. The user can select a webpage or one of predefined social media networks, for example, Tumblr.® of Tumblr, Inc., Facebook® of Facebook, Inc., Linkedin® of Linkedin Corporation, MySpace® of MySpace Inc., etc., as one of the content data streams.

Through the interactive space editor, the interactive content overlay and streaming application (ICOSA) provides the user with an option to select one of multiple views, each corresponding to a particular layout of the content panels, on the graphical user interface (GUI) of the user device. As used herein, “views” refer to display formats for displaying the content data streams on corresponding layouts of the content panels on the GUI. The ICOSA arranges the views in different formats, for example, a grid format, a list format, etc. The ICOSA creates the views based on the number of content data streams to be displayed on the GUI. In an embodiment, the ICOSA allows the user to select available views on the GUI. In another embodiment, the ICOSA allows a user to create new views based on the number of content data streams to be displayed on the GUI. In an embodiment, the ICOSA arranges the selected view in a portrait layout or a landscape layout according to the user device. The ICOSA displays multiple content data streams based on the received view on the GUI. A user selects one or more of the content data streams from the displayed content data streams. The ICOSA receives the user selection of the content data streams from the displayed content data streams. The ICOSA receives one or more of the content data streams in one or more of the content formats from different content sources based on the received user selection.

When the interactive content overlay and streaming application (ICOSA) receives a request to record the user media content from the user device, the ICOSA records 103a the user media content on the user device using a media and event recorder of the user device while streaming the selected content data streams on the graphical user interface (GUI). The ICOSA streams the selected content data streams to the user device from the corresponding content sources. The content overlay and streaming server (COSS) dynamically receives the user media content being recorded on the user device over the network. In an embodiment, the ICOSA continuously stores the user media content being recorded in a local video file in a database of the user device. In this embodiment, the ICOSA deployed on the user device executes a background software application that transmits a portion of the user media content that has been recorded to the COSS over the network in parallel with a recording application that records the user media content using a processor of the user device. In this embodiment, the COSS dynamically receives the user media content being recorded through the background software application running on the user device. A generic computer using a generic program cannot perform the step of dynamically receiving the user media content onto a server while the user media content is being recorded on a user device. The ICOSA overlays 104a the user media content being recorded on the selected content data streams being streamed on the GUI, for example, as a picture-in-picture video.

During the recording of the user media content, the interactive content overlay and streaming application (ICOSA) records 105 content panel events and synchronization data on the user device. As used herein, “content panel event” refers to an event other than the recording of the user media content and the user media content itself that is obtained during the recording of the user media content. The content panel events comprise, for example, layout changes in the content panels on the graphical user interface (GUI), changes in an orientation of the user media content, buffering of the selected content data streams being streamed during the recording of the user media content, etc. For example, if the user media content that is being recorded is overlaid on a content data stream comprising a video from YouTube®, buffering of the video due to a slowdown in speed of data traffic over a network connection between the user device and the YouTube® server on the internet becomes a content panel event. Content panel events further comprise, for example, creation of additional content panels with content data streams, deletion of content panels, and updates to the content panels such as changes in size of a content panel, layout of the content panels in the interactive space editor on the GUI, etc.

Also, as used herein, “synchronization data” refers to data that is used for synchronizing the content data streams with the user media content. The synchronization data comprises, for example, information on time at which the recording of the user media content is initiated, time at which each of the content panel events is recorded, time at which the recording of the user media content is terminated by the interactive content overlay and streaming application (ICOSA), etc. In an embodiment, the ICOSA records the time at which each content panel event is recorded and the time at which the recording of the user media content is terminated relative to the time at which the recording of the user media content is initiated. In this embodiment, the content panel events and the synchronization data are recorded in software objects in a database on the user device. In this embodiment, the duration of the recording of the user media content comprising information on time at which the recording of the user media content is initiated and the time at which the recording of the user media content is terminated is recorded in a separate software object in the database. A generic computer using a generic program cannot perform the step of seamlessly recording the content panel events and the synchronization data that depend on inputs of a user of the user device via the graphical user interface (GUI) provided by an application on the user device and on network conditions of a network to which the user device is connected.

When the interactive content overlay and streaming application (ICOSA) receives a request for terminating the recording of the user media content from the user device, the ICOSA terminates the recording of the user media content. The content overlay and streaming server (COSS) receives 106a the recorded user media content, the recorded content panel events, and the recorded synchronization data from the user device via the ICOSA. The COSS generates 107 a content media object by processing the received user media content. As used herein, “content media object” refers to a software container that comprises links to the processed user media content, the selected content data streams, the content panel events, and the synchronization data. The COSS processes the received user media content to create different formats of the received user media content and generate a thumbnail of the received user media content. The COSS provides access of the processed user media content, the selected content data streams, the received content panel events, and the received synchronization data to viewer devices through the generated content media object. The user device that is used to record the user media content is also a viewer device. The COSS provides the access of the processed user media content and the selected content data streams to the viewer devices by sending the generated content media object to the ICOSA deployed on each of the viewer devices for displaying the generated content media object on the graphical user interface (GUI) provided by the ICOSA on each of the viewer devices. A generic computer using a generic program cannot perform the step of processing user media content recorded on a user device on a server, generating a content media object of the processed media content and content data streams from different content sources on the server, and distributing the generated content media object to viewer devices.

When a user of a viewer device accesses the generated content media object via the graphical user interface (GUI) of the interactive content overlay and streaming application (ICOSA) deployed on the viewer device, the ICOSA overlays 108a the processed user media content and an interaction panel on the selected content data streams on the GUI. As used herein, “interaction panel” refers to an interactive graphical component, for example, a chat panel that receives interaction media entered by the user of the viewer device and displays interaction media entered by users of other viewer devices via the GUI of the ICOSA. Also, as used herein, “interaction media” refers to comments, messages, etc., of the users of the viewer devices who consume the processed user media content and the selected content data streams on the GUI of the ICOSA deployed on each of the viewer devices. The comments comprise, for example, textual data, emoticons, animations, links to webpages, etc. In an embodiment, the comments further comprise audiovisual data. The ICOSA deployed on the viewer device receives the user media content and the selected content data streams from the content overlay and streaming server (COSS) and lays out the content panels with the selected content data streams in accordance with the view that was selected on the user device on which the user media content was recorded.

The interactive content overlay and streaming application (ICOSA) streams 109a the selected content data streams and the overlaid user media content, and displays comments entered in the interaction panel from the viewer devices via the graphical user interface (GUI) deployed on each of the viewer devices. In an embodiment, the ICOSA implements the interaction panel as a software object for displaying the interaction panel on the GUI. In this embodiment, the ICOSA deployed on each viewer device sends the interaction media entered by a user of the viewer device in the interaction panel on the GUI to the content overlay and streaming server (COSS). The ICOSA deployed on each viewer device receives the interaction media entered by the users of the viewer devices from the COSS and updates the software object of the interaction panel with the received interaction media. A generic computer using a generic program cannot perform the step of overlaying and streaming media content from different sources, that is, the user media content from the COSS, the selected content data streams from the corresponding content sources, and the comments from other viewer devices, in real time on a viewer device.

The interactive content overlay and streaming application (ICOSA) synchronizes 110a the selected content data streams being streamed in real time with the overlaid user media content being streamed using the received content panel events and the received synchronization data. The ICOSA deployed on each viewer device receives the content panel events and the synchronization data from the content overlay and streaming server (COSS). The ICOSA refers to the content panel events that correspond to the layout changes in the content panels on the graphical user interface (GUI), the control panel events that correspond to the changes in an orientation of the user media content, and the control panel events that correspond to the buffering of one or more of the selected content data streams being streamed during the recording of the user media content. The ICOSA recreates the content panel events related to the layout changes in the content panels at the time that the changes occurred during the recording of the user media content using the information on the corresponding time in the synchronization data. Moreover, the ICOSA changes the orientation of the overlaid user media content according to the changes in the orientation of the user media content made during recording of the user media content at a time that corresponds to the time obtained from the synchronization data. Furthermore, the ICOSA suspends the streaming of the overlaid user media content and the selected content data streams at a time corresponding to the time of buffering of the selected content data streams during the recording of the user media content. The ICOSA resumes the streaming of the overlaid user media content and the selected content data streams at a time corresponding to the time of exit of the selected content data streams from a buffering state.

The interactive content overlay and streaming application (ICOSA) synchronizes the streaming of the overlaid user media content and the selected content data streams with network events and/or data transfer events at the time of the streaming. The network events refer to events, for example, temporary loss of connectivity over the network, variations in speed of data traffic over the network, etc., on the network over which the overlaid user media content and the selected content data streams are being streamed. The data transfer events refer to events, for example, temporary loss of connectivity with a storage device, load on a processor of the viewer device, etc., pertaining to transfer of data from storage devices to the viewer device. The ICOSA suspends the streaming of the overlaid user media content and the selected content data streams when any one of the selected content data streams or the user media content enters a buffering state. The ICOSA resumes the streaming of the overlaid user media content and the selected content data streams when all the selected content data streams and the overlaid user media content have buffered to a predetermined extent. The predetermined extent refers to a predetermined quantity of data in a storage facility, for example, a database, in the viewer device. In an embodiment, the ICOSA calculates the predetermined quantity of data by taking into account the network conditions comprising, for example, speed of data traffic over a network, and/or data transfer conditions comprising, for example, transfer speed from a storage device to the viewer device, etc. A generic computer using a generic program cannot perform the step of synchronizing media content from different sources, that is, the user media content from the COSS and the selected content data streams from the corresponding content sources, in response to different events in real time on a viewer device. The different events comprise, for example, the content panel events during recording of the user media content and network conditions during the streaming of the processed user media content and the selected content data streams.

FIG. 1B exemplarily illustrates an embodiment where the computer implemented method overlays user media content on live content data streams and synchronizes the live content data streams in real time with the overlaid user media content. As used herein, “live content data streams” refer to live content streamed or loaded from different live content sources, for example, a live video feed from Live Nation® of Live Nation Worldwide, Inc. The live content data streams comprise, for example, live cable television content, live video content, etc. Also, as used herein, “live content sources” refer to sources that broadcast live content over a wired or wireless network, for example, the internet. The computer implemented method disclosed herein employs the interactive content overlay and streaming system (ICOSS) comprising at least one processor configured to execute computer program instructions for overlaying user media content on live content data streams and synchronizing the live content data streams in real time with the overlaid user media content. As disclosed in the detailed description of FIG. 1A, the ICOSS comprises the interactive content overlay and streaming application (ICOSA) deployed on the user device and the content overlay and streaming server (COSS) in communication with the ICOSA over a network, for example, the internet, an intranet, a wired network, a wireless network, a mobile telecommunication network, etc. The interactive content overlay and streaming application (ICOSA) renders 101 an interactive space editor with multiple content panels on the graphical user interface (GUI) deployed on the user device. The content panels comprise links to the live content data streams from multiple live content sources, for example, live event streaming websites on the internet. The COSS receives 102b a selection of one or more of the live content data streams to be rendered on the content panels of the interactive space editor from the user device via the ICOSA installed on the user device as disclosed in the detailed description of FIG. 1A.

When the interactive content overlay and streaming application (ICOSA) receives a request to record the user media content from the user device, the ICOSA records 103b the user media content on the user device using the media and event recorder of the user device while streaming the selected live content data streams on the graphical user interface (GUI). The ICOSA overlays 104b the user media content being recorded on the selected live content data streams being streamed on the GUI, for example, as a picture-in-picture video. During the recording of the user media content, the ICOSA records 105 content panel events and synchronization data on the user device as disclosed in the detailed description of FIG. 1A. The content overlay and streaming server (COSS) dynamically receives 106b the user media content being recorded, the content panel events being recorded, and the synchronization data being recorded from the user device during the recording of the user media content. The COSS dynamically receives the user media content being recorded, the content panel events being recorded, and the synchronization data being recorded over the network through a background software application running on the user device as disclosed in the detailed description of FIG. 1A. The COSS generates 107 a content media object by processing the received user media content as disclosed in the detailed description of FIG. 1A.

When a user of a viewer device accesses the generated content media object via the graphical user interface (GUI) of the interactive content overlay and streaming application (ICOSA) deployed on the viewer device, the ICOSA overlays 108b the processed user media content and an interaction panel on the selected live content data streams on the GUI as disclosed in the detailed description of FIG. 1A. The ICOSA streams 109b the selected live content data streams and the overlaid user media content, and displays comments entered in the interaction panel from the viewer devices via the GUI deployed on the viewer devices as disclosed in the detailed description of FIG. 1A. The ICOSA synchronizes 110b the selected live content data streams being streamed in real time with the overlaid user media content being streamed using the received content panel events and the received synchronization data as disclosed in the detailed description of FIG. 1A.

In the embodiment disclosed above, the interactive content overlay and streaming system (ICOSS) simultaneously records the user media content on the user device and overlays the user media content being recorded on the user device and the interaction panel on the selected live content data streams on the graphical user interface (GUI) deployed on each of the viewer devices. Consider an example where a user of the user device selects a live video feed of a sports event as a live content data stream via the interactive content overlay and streaming application (ICOSA) installed on the user device. The content overlay and streaming server (COSS) receives the selection of the live video feed of the sports event via the ICOSA installed on the user device. The ICOSA records a commentary by the user of the user device while streaming the live video feed of the sports event on the GUI and overlays the commentary being recorded on the live video feed of the sports event being streamed. During the recording of the commentary, the ICOSA continuously stores the commentary being recorded along with any content panel events and synchronization data in a local video file in a database of the user device. The content panel events comprise, for example, addition of a content panel showing a webpage with results of a previous sports match between two teams playing in the sports event whose live video feed is currently being streamed, sizing of the added content panel, and subsequent removal of the added content panel. The synchronization data comprises, for example, information on the time at which the content panel showing the webpage was added, the time at which the content panel was resized, and the time at which the content panel was removed, for example, relative to the time at which the recording of the commentary was initiated by the ICOSA installed on the user device. The synchronization data further comprises, for example, the time at which the recording of the commentary initiated relative to a time in the live video feed of the sports event, for example, a timestamp of a video frame in the live video feed of the sports event received from an internet server broadcasting the live video feed of the sports event. The ICOSA executes the background software application that transmits a portion of the commentary that has been recorded along with the content panel events and the synchronization data that have been recorded to the COSS over the network in parallel with the recording application that records the commentary using the processor of the user device.

The content overlay and streaming server (COSS) processes the received commentary to generate a suitable video format of the commentary that can be viewed on different viewer devices, for example, smartphones and tablet computing devices. The COSS generates a content media object, for example, in the form of a thumbnail portraying the commentary and the live video feed of the sports event to provide access of the commentary and the live video feed of the sports event to the viewer devices. When a viewer device selects the thumbnail via the interactive content overlay and streaming application (ICOSA) installed on the viewer device, the COSS sends an access link to the live video feed of the sports event and the processed commentary to the ICOSA installed on the viewer device. The COSS continuously receives the commentary being recorded on the user device along with the content panel events and the synchronization data, processes the received commentary, and sends the processed commentary to the viewer device. The ICOSA installed on the viewer device overlays the processed commentary sent by the COSS and the interaction panel on the live video feed of the sports event on the GUI installed on the viewer device. The ICOSA streams the live video feed of the sports event and the overlaid commentary on the GUI installed on the viewer device. The ICOSA installed on the viewer device synchronizes the live video feed of the sports event with the processed commentary using the content panel events and the synchronization data dynamically received from the COSS. The ICOSA installed on the viewer device begins streaming the live video feed of the sports event from the internet server that broadcasts the sports event, at a time in the live video feed of the sports event at which the recording of the commentary commenced using the corresponding information in the received synchronization data. The interactive content overlay and streaming system (ICOSS) allows the viewer devices to view the commentary being recorded, on the viewer device simultaneously with the recording of the commentary on the user device. Hence, live content data streams are streamed on viewer devices with an overlay of user media content being recorded on the user device.

When recording the user media content on the user device, the interactive content overlay and streaming application (ICOSA) installed on the user device creates a file in a multimedia container format, for example, a moving picture experts group-4 part 14 (mp4) format, from the recording on the user device. The ICOSA uploads the created file to the content overlay and streaming server (COSS) for encoding. The COSS performs the encoding to ensure that the file is processed into a consistent digestible format for redistributing the file back to the ICOSA installed on each of the viewer devices. The multimedia container for the file, for example, in the mp4 format, contains audio, video, and time sequences. When a user of a viewer device plays back the processed user media content and a selected content data stream, for example, a video from YouTube®, the ICOSA installed on the viewer device retrieves two video streams, that is, the content data stream from the YouTube® source and the processed user media content from the COSS. The ICOSA installed on the viewer device buffers both the video streams and places the video streams on different layers, for example, the content data stream on layer 0 and the user media content on layer 1 as a window. The ICOSA installed on the viewer device places layer 1 on top of layer 0 to float on layer 0. The ICOSA installed on the viewer device checks time synchronization between the content data stream and the user media content every few frames, for example, for key frames in the video of the user media content, to ensure that one video stream is not playing faster or slower than the other video stream. A generic computer using a generic program cannot perform the steps of layering a graphical user interface (GUI) for simultaneous display of multiple pieces of media content and synchronizing the simultaneously displayed media content with each other.

Consider an example where a user records a commentary in a video of himself or herself to be overlaid onto an existing video as a picture-in-picture video. The user of a user device invokes the interactive content overlay and streaming application (ICOSA) installed on the user device. The user creates a new view via the graphical user interface (GUI) provided by the ICOSA on the user device. The user selects a video from a list of videos available in a guide displayed on the GUI. The ICOSA plays the video selected by the user in an original view on the GUI. The user taps on the playing video, which in turn renders a menu on the GUI of the ICOSA. The user selects a self video option present in the menu. The self video option is similar to a self-captured image. The self video option allows the user to record a video of himself or herself, herein referred to as a “self video”, and broadcast the recorded self video. The ICOSA overlays the recorded self video on the user selected video. The recorded self video comprises, for example, a description related to the user selected video in a voice recording format, for example, a commentary. The interactive content overlay and streaming system (ICOSS) streams the user selected video with the overlaid self video live to an audience or stores the user selected video with the overlaid self video in a server database for later retrieval. The user may tap on the GUI to pause or stop the streaming user selected video with the overlaid self video.

The method and the interactive content overlay and streaming system (ICOSS) disclosed herein improves the functionality of a computing device, for example, a user device, a viewer device, etc., and provides an improvement in computer related technology as follows: The interactive content overlay and streaming application (ICOSA) installed on a viewer device streams the processed user media content from the content overlay and streaming server (COSS) and the selected content data streams from the content sources. The ICOSA overlays the streaming processed user media content on the streaming selected content data streams and synchronizes the streaming selected content data streams in real time with the streaming processed user media content using the content panel events and the synchronization data retrieved from the COSS. The ICOSA, in communication with the COSS, digitally overlays the processed user media content and the selected content data streams on the viewer device, without the use of multiplexer devices and analog methods, thereby precluding the need for additional hardware beyond the viewer device. Moreover, the ICOSS streamlines the creation and sharing of reaction videos using the ICOSA installed on the user device and on each of the viewer devices, and a connection over a network to the COSS. The ICOSS precludes the use of additional software tools for post processing of recorded videos for overlaying and synchronizing digital signals. The ICOSS hence requires less processing time and few resources on the user device and the viewer devices. Furthermore, the ICOSS streams the selected content data streams with an overlay of the processed user media content in real time without requiring creation of a media content file with the selected content data streams and the processed user media content already overlaid thereon. Hence, the ICOSS makes optimum usage of data storage capacity both on the user device and the COSS by precluding the need for storing a third media content file comprising media content from two media content files that are already stored on servers. The software implementation of the ICOSA on the user device and each of the viewer devices, and the COSS of the ICOSS is an improvement in computer related technology.

The focus of the method and the interactive content overlay and streaming system (ICOSS) disclosed herein is on an improvement to the computer functionality itself, and not on economic or other tasks for which a generic computer is used in its ordinary capacity. Accordingly, the method and the ICOSS disclosed herein are not directed to an abstract idea. Rather, the method and the ICOSS disclosed herein are directed to a specific improvement to the way the computers in the ICOSS operate, embodied in, for example, dynamic reception of the user media content, the control panel events, and the synchronization data being recorded on the user device, the generation of the content media object, overlay of the processed user media content and the interaction panel on the selected content data streams on the graphical user interface (GUI) deployed on each of the viewer devices, streaming of the selected content data streams and the overlaid user media content, display of comments entered in the interaction panel from the viewer devices via the GUI deployed on each of the viewer devices, synchronization of the selected content data streams being streamed in real time with the overlaid user media content being streamed using the received content panel events and the received synchronization data, etc.

The data input to computing devices, for example, the user device, the content overlay and streaming server (COSS), and each of the viewer devices is transformed as follows: The interactive content overlay and streaming system (ICOSS) provides the interactive content overlay and streaming application (ICOSA) on the user device and each of the viewer devices. The ICOSA renders the graphical user interface (GUI) that receives inputs from a user of the user device or the viewer device. The inputs in the form of selections of thumbnails displayed on the GUI are interpreted as selections of the content data streams and passed to the COSS. When a user of the user device sends a request to the ICOSA via the GUI to record the user media content, the ICOSA receives an audiovisual feed from the user device using the media and event recorder on the user device and transforms the audiovisual feed to a multimedia container format. The ICOSA saves the transformed audiovisual feed to a media container file on the user device. As the user media content is being recorded, the ICOSA dynamically sends a portion of the user media content that has been recorded to the COSS. Hence, a live feed of audiovisual content from the media and event recorder of the user device is available on the COSS that processes the live feed and simultaneously sends the processed live feed to viewer devices for consumption. The audiovisual content that is an analog signal is transformed into a digital signal that is transmitted over large distances from a user device to viewer devices. Moreover, the live feed from the user device is overlaid on a content data stream that may be another live feed being broadcast over a network on the viewer device. Furthermore, the COSS transforms the recorded user media content, the recorded content panel events, and the recorded synchronization data received from the user device into a content media object that provides access of the recorded user media content and the selected content data streams to the viewer devices. Furthermore, the ICOSS receives comments from viewer devices that are consuming media content via the GUI of the ICOSA installed on each of the viewer devices and broadcasts the comments as an overlay on the GUI of each of the other viewer devices consuming the same media content through a network. Furthermore, the ICOSS adjusts resolution and/or display size of the streaming content data streams and the streaming user media content to fit different screen sizes of the viewer devices, for example, smartphones, tablet computing devices, etc. The ICOSS transforms analog signals to digital signals, and digital signals to other formats suitable for consumption on different viewer devices as an overlay over other digital signals.

The interactive content overlay and streaming system (ICOSS) overlays recorded media content, that is, the user media content, from a user device on relevant streaming content data streams selected by a user of the user device. Moreover, the ICOSS synchronizes the content data streams being streamed with the user media content being overlaid in real time. Furthermore, the ICOSS records the user media content and overlays the recorded user media content on the streaming selected content data streams without altering the selected content data streams being streamed. Furthermore, the ICOSS overlays a virtual component in the form of the interaction panel on the content data streams being viewed on the graphical user interface (GUI) of each viewer device to render comments of users viewing the content data streams in real time without altering the content data streams being viewed. In an embodiment, the ICOSS enables users to enjoy live video, cable, web surfing, texting, blogging, live interactive chats either personally with multiple friends or in a group conference, social networking through social media sites, etc., by accessing any combination of digital data or content data or video streams within the GUI provided by the interactive content overlay and streaming application (ICOSA), and share a cornucopia of digital information, for example, via text, video, electronic mail (email), live chats, etc. The end result of overlaying user media content on content data streams and synchronizing the content data streams in real time with the user media content obtained is tangible and not abstract.

In the computer implemented method disclosed herein, the design and the flow of interactions in the interactive content overlay and streaming system (ICOSS) between the interactive content overlay and streaming application (ICOSA) installed on the user device and on each of the viewer devices and the content overlay and streaming server (COSS) are deliberate, designed, and directed. Every prompt, every question, etc., the user receives via the graphical user interface (GUI) is configured by the ICOSS to steer the user towards a finite set of predictable outcomes. The ICOSS implements one or more specific computer programs to direct the user towards a set of end results. The interactions designed by the ICOSS allow the ICOSS to collect information comprising the selection of the content data streams, the request for recording the user media content from the user of the user device, and the request for accessing the processed user media content and the selected content data streams from the user of the viewer device. From this information, the ICOSS, through the use of another, separate and autonomous computer program, infers the user's intentions. This inference is used as a trigger to recording of the user media content, stream the selected content data streams, and overlay the user media content being recorded on the streaming content media streams until the recording of the user media content is terminated by the user on the user device. Moreover, the ICOSS uses the inference as a trigger to overlay the processed user media content on the selected content data streams, stream the processed user media content and the selected content data streams, and synchronize the selected content data streams in real time with the processed user media content on the viewer devices. To record the user's actions, infer his/her intentions, trigger recording of the user media content, overlay the user media content on the content data streams, stream the content data streams and the overlaid user media content, display comments in the interaction panel from the viewer devices, and synchronize the content data streams in real time with the overlaid user media content using the control panel events and the synchronization data requires seven or more separate computer programs, the execution of which cannot be easily or manually performed by a person using a generic computer.

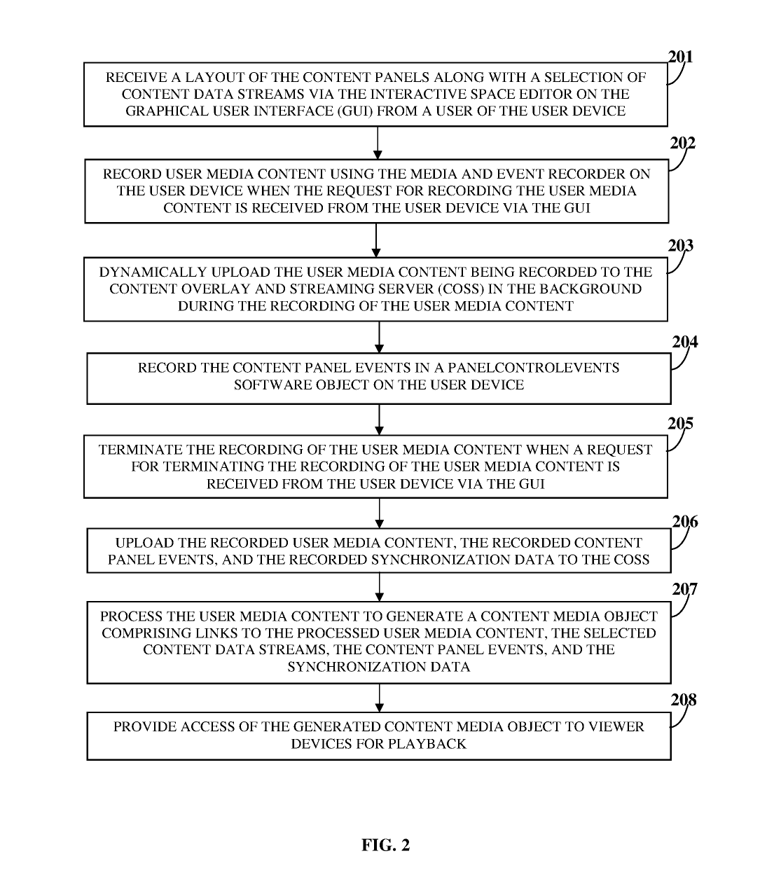

FIG. 2 exemplarily illustrates a flow diagram comprising the steps performed by the interactive content overlay and streaming system (ICOSS) for recording user media content and content panel events and generating a content media object for playback of the recorded user media content on a content data stream. The interactive content overlay and streaming application (ICOSA) deployed on a user device receives 201 a layout of the content panels along with a selection of content data streams via the interactive space editor on the graphical user interface (GUI) of the ICOSA from a user of the user device. The user uses the interactive space editor that provides a space comprising multiple content panels and overlaid user media content, for example, as picture-in-picture video. The content panels comprise links to content data streams of different media types, for example, video, web, social media, etc. The user media content, for example, the picture-in-picture video is a feed from the media and event recorder, for example, a camera, on the user device. The user presses a record button on the user device. The ICOSA records 202 user media content using the media and event recorder on the user device when the request for recording the user media content is received from the user device via the GUI. The ICOSA simultaneously streams the selected content data streams in the content panels. When the ICOSS receives the selected content data streams and the request to record the user media content, the ICOSS activates the media and event recorder of the user device to record the user media content and overlays the user media content being recorded on the content data streams. If the user is recording the user media content against a content data stream that is a video, the video automatically begins playing and syncing the time to the user's recording of the user media content. In an embodiment, the ICOSA starts recording the user media content, for example, the video stream of the media and event recorder to a local moving picture experts group-4 part 14 (mp4) video file on the user device. The ICOSA implements software objects in a memory unit of the user device. Software objects labeled PanelControlEvents store the content panel events. A software object labeled TimeSyncSource belongs to the space provided by the interactive space editor and stores the synchronization data. The software objects PanelControlEvents are synched to the software object TimeSyncSource and are managed by a software object labeled ViewModel related to the recording of the user media content. The software object ViewModel stores the view selected by the user of the user device.

The interactive content overlay and streaming application (ICOSA) dynamically uploads 203 the user media content being recorded to the content overlay and streaming server (COSS) in the background during the recording of the user media content. The ICOSA records 204 the content panel events in the software objects labeled PanelControlEvents on the user device. Any changes to the configuration of the content panels in the space provided by the interactive space editor are stored locally on the user device in the software objects PanelControlEvents. Any changes to the orientation of the user media content being recorded or the content panels are also stored as PanelControlEvents. If a video is being streamed in a content panel in the space, then PanelControlEvents are also created whenever the video leaves or enters a buffering state to facilitate time synchronization between the recorded user media content and the selected content data streams during subsequent playback of the recorded user media content and the selected content data streams on a viewer device.

The user presses a button on the user device to terminate the recording of the user media content. The ICOSA terminates 205 the recording of the user media content when a request for terminating the recording of the user media content is received from the user device via the graphical user interface (GUI). The ICOSA updates the status of the space to an initial status, that is, the status of the space before selection of the content data streams by the user, and generates a preview of the recorded user media content and the selected content data streams. The ICOSA marks the space to be in a state of the user media content having been recorded with a pending upload to the content overlay and streaming server (COSS). The ICOSA stores the duration of the recording of the user media content in a software object labeled RecordedSession. In an embodiment, the software object RecordedSession also stores the data of the PanelControlEvents and TimeSyncSource software objects. The ICOSA stores the RecordedSession and the space with the content panels while the user media content is recorded in a backend database. The ICOSA requests an upload manager provided in the ICOSA to prioritize uploading of the recorded user media content of the space, that is, the picture-in-picture video to the COSS. The upload manager in the ICOSA uploads 206 the recorded user media content, the recorded content panel events, and the recorded synchronization data to the COSS. Upon successful upload, the COSS processes 207 the user media content to generate a content media object comprising links to the processed user media content, the selected content data streams, the content panel events, and the synchronization data. The COSS also generates thumbnails, additional digital formats of the recorded user media content, etc. Once media processing is completed, the ICOSA sets the space as available for playback on the user device. The COSS provides 208 access of the generated content media object to viewer devices for playback, that is, consumption of the processed user media content and the selected content data streams by the viewer devices. The steps disclosed above that are performed by the interactive content overlay and streaming system (ICOSS) for recording the user media content and content panel events form the first part of a two part process for providing a synchronized user video overlay over the space provided by the interactive space editor.

An example of a pseudocode used to program the interactive content overlay and streaming application (ICOSA) executable by at least one processor of the user device for recording the user media content is provided below:

```
Class VideoRecorderService{
  Function StartRecording( ){
    Get initial state of Space and store as StateOfWorld snapshot
    Start RecordingPlaybackSynchronizer
    Start TimeTracker
    Register for panel events
    Start recording local AV
    Tell UploadManager to prioritize upload of current AV to server
  }
  Function Stop( ){
    Unregister panel events
    Stop RecordingPlaybackSynchronizer
    Stop TimeTracker
    Stop recording local AV
    Set duration of recorded session to the TimeTracker current time
    Display FinishScreen
  }
}
```

An example of a pseudocode used to program the interactive content overlay and streaming application (ICOSA) executable by at least one processor of the user device for tracking a start and an end of the recording of the user media content is provided below:

```
Class TimeTracker{
  Function Start( ){
    Start timer
  }
  Function Stop( ){
    Stop timer
  }
  Function GetCurrentTime( ){
    Return current timer time
  }
}
```

An example of a pseudocode used to program the interactive content overlay and streaming application (ICOSA) executable by at least one processor of the user device for recording the content panel events during the recording of the user media content is provided below:

```
Class RecordingPlaybackSynchronizer{
  Function Start( ){
    Listen for panel control events
    Set buffering to true
  }
  Function HandlePanelControlEvents( ){
    If (event is VideoSourceAddedEvent){
      Remove listeners from current event source, if any
      Set the current video source to the event's source
    }
    If (event is VideoSourceRemovedEvent){
      Remove listeners from event source
    }
    If (event is videobuffering event){
      Add a buffering start panel control event to the recorded session
    }
    If (event is video stopped buffering event){
      Add a buffering ended panel control event to the recorded session
    }
  }
  Function Stop( ){
    Stop listening for panel control events
  }
}
```

An example of a pseudocode used to program the interactive content overlay and streaming application (ICOSA) executable by at least one processor of the user device for displaying status of the recording of the user media content on the graphical user interface (GUI) of the ICOSA is provided below:

```
View FinishScreen{
  Function OnShow( ){
    While (progress < 100% and upload is not failed){
      Display progress bar of current upload progress
    }
    If (upload succeeded){
      Display success message
    }
    If (upload failed){
      Display failure message
    }
    Go to home screen
  }
}
```

An example of a pseudocode used to program the interactive content overlay and streaming application (ICOSA) executable by at least one processor of the user device for uploading the recorded user media content, the recorded content panel events, and the recorded synchronization data to the content overlay and streaming server (COSS) is provided below:

```
Class UploadManager{
  Function prioritize(selfeo){
    Mark the passed in selfeo as the priority for the queue
  }
  Function start( ){
    Running = true
    While (running){
      If (selfeo in queue){
        Request upload token from server
        While (video parts remain to be uploaded or not failed){
          Upload parts to server using upload token
        }
      If (all parts uploaded){
        Notify server that the selfeo is uploaded and can be
        processed
        Broadcast message to indicate selfeo was uploaded
      }
    }
  }
  Function Stop( ){
    Running = false;
  }
}
```

In the above pseudocode, “selfeo” refers to a media object comprising the user media content that is to be overlaid on the selected content data streams.

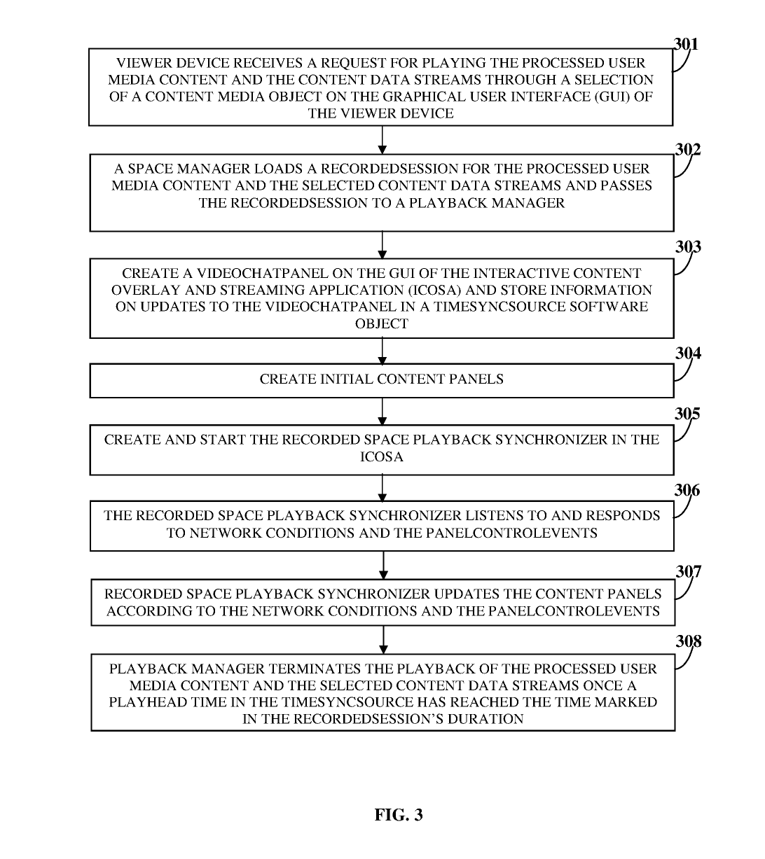

FIG. 3 exemplarily illustrates a flow diagram comprising the steps performed by the interactive content overlay and streaming system (ICOSS) for overlaying processed user media content and an interaction panel on content data streams on the graphical user interface (GUI) provided by the ICOSS on viewer devices and synchronizing the content data streams in real time with the overlaid user media content. The steps performed by the ICOSS for overlaying the processed user media content and the interaction panel on the content data streams on the GUI of the interactive content overlay and streaming application (ICOSA) on each of the viewer devices and synchronizing the content data streams in real time with the overlaid user media content form the second part of the two part process for providing a synchronized user video overlay over the space provided by the interactive space editor. The ICOSA installed on a viewer device receives 301 a request for playing, that is, for accessing the processed user media content and the content data streams through a selection of a content media object on the GUI of the ICOSA on the viewer device. A software module referred to as a “space manager” that is provided in the ICOSA installed on the viewer device loads 302 the software object RecordedSession for the processed user media content and the selected content data streams and passes the RecordedSession to a playback manager provided in the ICOSA. The space manager also displays the space of the recorded user media content and the selected content data streams while the playback manager initializes. Playback, that is, consumption of the processed user media content and the selected content data streams does not start yet and is disabled by the playback manager.

The playback manager creates 303 the interaction panel labeled VideoChatPanel on the graphical user interface (GUI) of the interactive content overlay and streaming application (ICOSA) and stores information on updates to the VideoChatPanel in the TimeSyncSource software object. The updates to the VideoChatPanel comprise, for example, comments of users of the viewer devices on the processed user media content and the selected content data streams after the playback starts. The playback manager creates the VideoChatPanel as an overlay on a content panel with the processed user media content on the GUI of the ICOSA installed on each of the viewer devices. The playback manager begins to stream the processed user media content, for example, a picture-in-picture video file, from the content overlay and streaming server (COSS) without playing back the picture-in-picture video file. The playback manager also listens to the PanelControlEvents software object to obtain information regarding the orientation of the picture-in-picture video and rotates the picture-in-picture video if required, to match the orientation in which the picture-in-picture video was during the recording of the picture-in-picture video. Furthermore, the playback manager recreates the content panel events by dispatching the PanelControlEvents that communicate whether the streaming picture-in-picture video has entered or left a buffering state. The playback manager creates 304 initial content panels, that is, the content panels that were present at time zero, that is, at a time at the start of the recording of the user media content on the user device. In an embodiment, the time zero is referred to as State Of World (SOW). The playback manager also streams the selected content data streams comprising videos in the respective content panels by loading the corresponding video files from the content sources using the links to the content data streams in the content panels without playing the videos back. The playback manager also dispatches PanelControlEvents that communicate whether the video files of the selected content data streams have entered or left a buffering state, or if content panels have been created or destroyed.

The playback manager creates and starts 305 a software module labeled recorded space playback synchronizer in the interactive content overlay and streaming application (ICOSA). The recorded space playback synchronizer listens 306 to and responds to network conditions and the PanelControlEvents. The recorded space playback synchronizer updates 307 the content panels according to the network conditions and the PanelControlEvents. The recorded space playback synchronizer listens for PanelControlEvents from the RecordedSession, for example, PanelControlEvents corresponding to changes to the content panels during the recording of the user media content, for example, the picture-in-picture video. The recorded space playback synchronizer also listens for PanelControlEvents corresponding to the picture-in-picture video, changes in the VideoChatPanel, and changes in any other content panels with video. Furthermore, the recorded space playback synchronizer suspends playback of the user media content, that is, the picture-in-picture video, and the selected content data streams if any of the videos in the selected content data streams that are currently playing are buffering. The recorded space playback synchronizer resumes playback once there is enough buffer, according to a predetermined amount of data, present to continue the playback. Furthermore, the recorded space playback synchronizer suspends the playback in response to PanelControlEvents that indicate that a content data stream, for example, a video in a content panel was buffering at any given time during recording of the user media content to ensure synchronization of the streaming of the selected content data streams with the processed user media content. Furthermore, the recorded space playback synchronizer resumes the playback in response to PanelControlEvents that indicate that the video that was buffering has exited the buffering state during the recording of the user media content.

The playback manager also listens for PanelControlEvents relating to creation of content panels and deletion of content panels, and updates the space provided by the interactive space editor accordingly during playback. Updating the space in turn updates the recorded space playback synchronizer, for example, in response to events that inform that a new content panel with a video and consequently the TimeSyncSource is to be observed, or that a content panel with a video has been removed. The playback manager terminates 308 the playback of the processed user media content and the selected content data streams once a playhead time, that is, the duration of the recording of the user media content, in the TimeSyncSource has reached the time marked in the RecordedSessions' duration.

An example of a pseudocode used to program the interactive content overlay and streaming application (ICOSA) executable by at least one processor of a viewer device for overlaying the processed user media content and the interaction panel on the content data streams on the graphical user interface (GUI) of the ICOSA and synchronizing the content data streams in real time with the user media content is provided below:

```
View SelfeoPlaybackView{
  Function OnShow(selfeo){
    Load RecordedSession for selfeo
    Load panels for selfeo, according to SOW and display them in a
    SelfeoView
    Load video overlay preview from location stored in
    RecordedSession
  }
  Function StartPlaying( ){
    Start RecordedPlaybackSynchronizer
    Register for panel events
  }
  Function Stop( ){
    Stop RecordedPlaybackSynchronizer
    Remove views, and cleanup
  Go to previous screen
  }
}
```

An example of a pseudocode used to program the interactive content overlay and streaming application (ICOSA) executable by at least one processor of the viewer device for synchronizing the selected content data streams being streamed on the graphical user interface (GUI) of the ICOSA with the overlaid user media content being streamed is provided below:

```
Class RecordedPlaybackSynchronizer{
  Function Start( ){
    Listen for panel control events
    Set buffering to true
  }
  Function HandlePanelControlEvents( ){
    If (event is VideoSourceAddedEvent){
      Ascertain if event source was a YouTube video, or the preview
      video
      Remove listeners from current event source, if any
      Set the current video source to the event's source
      Call UpdateStatus
    }
    If (event is VideoSourceRemovedEvent){
      Remove listeners from event source
      Call UpdateStatus
    }
    If (event is videobuffering event){
      Call UpdateStatus
    }
    If (event is video stopped buffering event){
      Call UpdateStatus
    }
  }
  Function Stop( ){
    Stop listening for panel control events
    Stop any videos playing
  }
  Function UpdateStatus( ){
    If (preview video is initialized){
      isBuffering = preview is buffering
    }
    If (!isBuffering){
      If (space should have YouTube video, but there is no YouTube
      video source) {
        isBuffering = true; //buffer while we wait for YouTube
        video to load
      }
    }
    If (!isBuffering){
      If (YouTube video is buffering) {
        isBuffering = true; //buffer while we wait for YouTube
        video to stop buffering
      }
    }
    If (!isBuffering){
      If (panel control events indicate that YouTube video was buffering
      at this point of the preview video's playback) {
        Pause the YouTube video
}
    }
    If (isBuffering){
      Pause selfeo preview video
      If (YouTube video is present){
        Pause YouTube video
      }
    } else {
      Play selfeo preview video
      If (YouTube video is present){
        Play YouTube video
      }
    }
}
```

An example of a pseudocode used to program the interactive content overlay and streaming application (ICOSA) executable by at least one processor of the viewer device for displaying a preview widget of the processed user media overlaid on the selected content data streams on the graphical user interface (GUI) of the ICOSA is provided below:

```
View VideoPreviewWidget{
  Function OnShow( ){
    If (recording){
      Show device camera
      Add device event listeners for rotate
    } else {
    Add panel control event listeners for rotate
      Show VideoPlayerView to display recorded video
    }
    Send event to broadcast that this view as a TimeSyncSource (used by
    synchronization managers)
    }
  Function OnPanelControlEvent(event){
    If (event is rotate){
      Update video playback rotation to match event
    }
  }
  Function OnDeviceRotate(event){
    Send PanelControlEvent with rotation direction
  }
}
```

An example of a pseudocode used to program the interactive content overlay and streaming application (ICOSA) executable by at least one processor of the viewer device for displaying a preview of the processed user media overlaid on the selected content data streams on the graphical user interface (GUI) of the ICOSA is provided below:

```
View VideoPlayerView{
  //used to display video preview view in playback and YouTube videos
  OnShow(panel){
  Load the url specified in the panel(for either YouTube or the preview
  video stored on server)
  Send Panel control event to register as time sync source
  Scrub to start time specified in panel
  Listen for video events
  }
  OnVideoEvent( ){
  Raise panel control event for start buffering, stop buffering or video failed
  }
}
```

An example of a pseudocode used to program the interactive content overlay and streaming application (ICOSA) executable by at least one processor of the viewer device for displaying the content panels in the selected view on the graphical user interface (GUI) of the ICOSA is provided below:

```
SelfeoView{
  Function onShow(Space){
    Create views for all panels in the space
    Register for space update events
  }
  Function OnSpaceUpdate(updatedSpace){
    newPanels = updatedSpace that are not in space
    removedPanels = panels that are in space but not in updatedSpace
    If (newPanels){
        Create new Panel Views using Panel ViewFactory and add
        them to space layout
    }
    If (oldPanels){
      Remove them from the view
    }
}
Class Panel ViewFactory{
  CreatePanelView(panel) : Panel View{
    Devises correct type of PanelView to create for a panel (e.g. video chat,
    Twitter, YouTube, etc.)
    Creates Panel View and configures it
    Return Panel View
  }
}
View Panel View{
  OnShow(panel){
    Configure the view to match the panel contents
  }
}
```

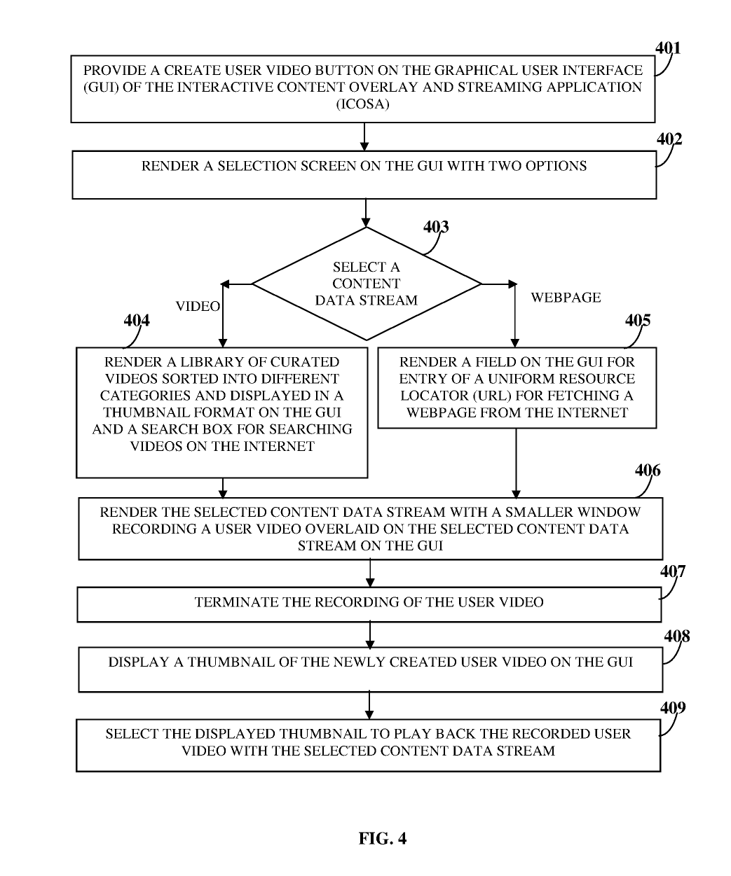

FIG. 4 exemplarily illustrates a flowchart for recording and playback of user media content as an overlay on a content data stream on a user device. The interactive content overlay and streaming application (ICOSA) installed on the user device provides 401 a create user video button on the graphical user interface (GUI) of the ICOSA. When a user of the user device clicks on the create user video button on the GUI, the ICOSA renders 402 a selection screen on the GUI with two options: one for recording the user video without a content data stream and the other for recording the user video with a content data stream. Consider the option for recording the user video with a content data stream. The content data stream is, for example, either a video or a webpage. If the user selects 403 a video for the content data stream, the ICOSA renders 404 a library of curated videos sorted into different categories and displayed in a thumbnail format on the GUI and a search box for searching videos on the internet, for example, on the YouTube® video sharing website. The user can select a video by either clicking on one of the curated videos on the GUI or searching for a video through a query on the YouTube® video sharing website using the provided search box. If the user selects 403 a webpage for the content data stream, the ICOSA renders 405 a field on the GUI to allow the user to enter a uniform resource locator (URL) for fetching the webpage from the internet.

The interactive content overlay and streaming application (ICOSA) renders 406 the selected content data stream, that is, the selected video being streamed or the selected webpage being displayed with a smaller window recording a user video overlaid on the selected video or the selected webpage on the graphical user interface (GUI). The smaller window is overlaid as a picture-in-picture window. The picture-in-picture window displays a user video from the media and event recorder, for example, a camera of the user device and begins recording the user video. The user can stop recording the user video at any time. On receiving a stop recording input from the user, the ICOSA terminates 407 the recording of the user video and displays 408 a thumbnail of the newly created user video on a personal newsfeed on the GUI. The user selects 409 the displayed thumbnail to play back the recorded user video with the selected content data stream.

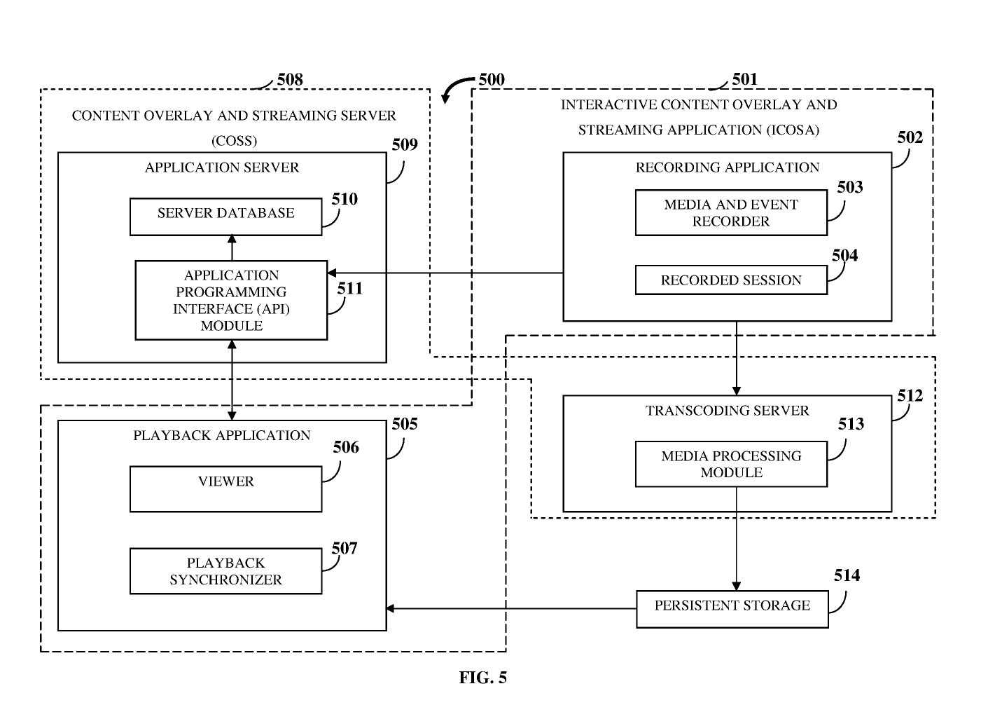

FIG. 5 exemplarily illustrates an implementation of the interactive content overlay and streaming system (ICOSS) 500, showing communication between modules of the ICOSS 500 for overlaying user media content on content data streams and synchronizing the content data streams in real time with the overlaid user media content. As disclosed in the detailed description of FIG. 1A, the ICOSS 500 comprises the interactive content overlay and streaming application (ICOSA) 501 installed on user devices and viewer devices, and the content overlay and streaming server (COSS) 508. As exemplarily illustrated in FIG. 5, the ICOSA 501 comprises a playback application 505 and a recording application 502. The playback application 505 comprises a viewer 506 that renders the graphical user interface (GUI) of the ICOSA 501. A user of a user device or a viewer device interacts with the ICOSA 501 via the GUI. The viewer 506 displays the interactive space editor with the content panels on the GUI for a selection of the views and the content data streams by the user of the user device via the GUI as disclosed in the detailed description of FIG. 1A. The playback application 505 further comprises a playback synchronizer 507 that synchronizes the selected content data streams being streamed on a viewer device in real time with the processed user media content being streamed using the content panel events and the synchronization data obtained from the COSS 508 as disclosed in the detailed description of FIG. 1A. The recording application 502 comprises the media and event recorder 503 that records the user media content when the ICOSA 501 receives a request to record the user media content from the user of the user device via the GUI. The recording application 502 further comprises a recorded session 504 that stores the duration of the recorded user media content, the content panel events, and the synchronization data as disclosed in the detailed description of FIG. 1A.

In an embodiment as exemplarily illustrated in FIG. 5, the content overlay and streaming server (COSS) 508 comprises an application server 509 and a transcoding server 512. The application server 509 comprises an application programming interface (API) module 511 and a server database 510. The API module 511 receives the content panel events and the synchronization data from the recording application 502 of the interactive content overlay and streaming application (ICOSA) 501 installed on the user device. The API module 511 stores the received content panel events and the received synchronization data in the server database 510. The API module 511 also receives requests for consumption of the processed user media content and the selected content data streams via the graphical user interface (GUI) from the playback application 505 of the viewer devices. The API module 511 then sends the received content panel events and the synchronization data stored in the server database 510 to the playback application 505 of the ICOSA 501 installed on each of the viewer devices. The transcoding server 512 receives the recorded user media content from the recorded session 504 of the recording application 502 installed on the user device. The transcoding server 512 comprises a media processing module 513 that processes the user media content and stores the processed user media content on a persistent storage 514, for example, a cloud storage server. After processing the user media content, the transcoding server 512 generates the content media object, which the API module 511 of the application server 509 of the COSS 508 sends to the viewer 506 of the playback application 505 on each of the viewer devices for providing access of the processed user media content and the selected content data streams.

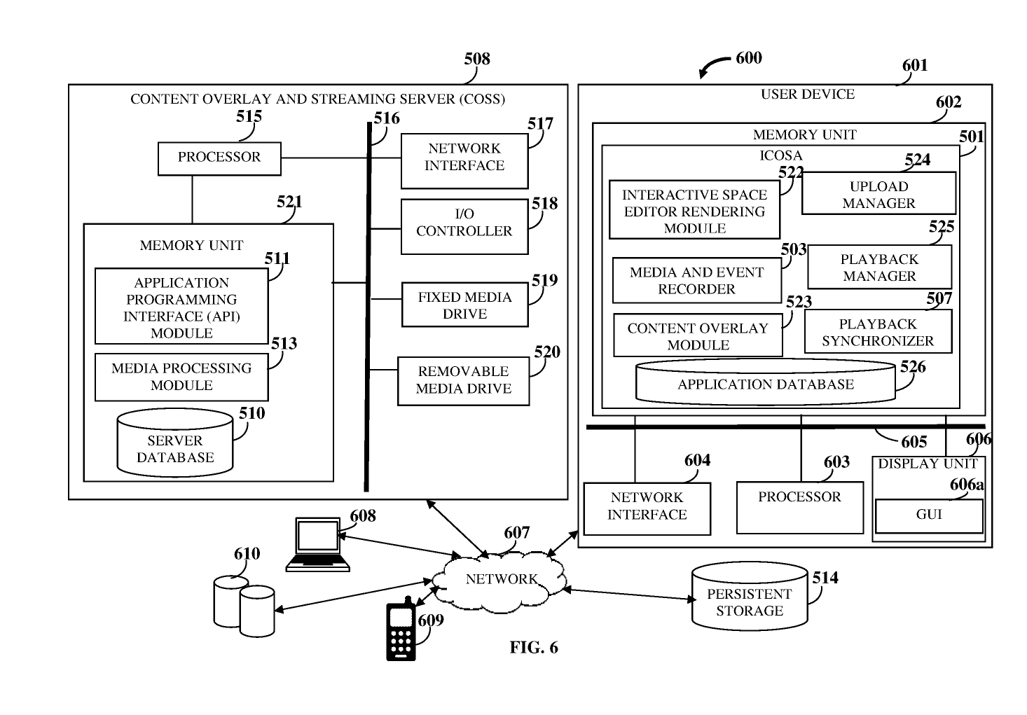

FIG. 6 exemplarily illustrates a computer implemented system 600 for overlaying user media content on content data streams and synchronizing the content data streams in real time with the overlaid user media content. In an embodiment, the computer implemented system 600 disclosed herein comprises the interactive content overlay and streaming application (ICOSA) 501 installed on a user device 601 and on each of the viewer devices 608 and 609, and the content overlay and streaming server (COSS) 508 communicating over a network 607, for example, a short range network or a long range network, for implementing the interactive content overlay and streaming system (ICOSS) 500 exemplarily illustrated in FIG. 5. The user device 601 and the viewer devices 608 and 609 are electronic devices, for example, personal computers, tablet computing devices, mobile computers, mobile phones, smartphones, portable computing devices, laptops, personal digital assistants, wearable devices such as the Google Glass® of Google Inc., the Apple Watch® of Apple Inc., etc., touch centric devices, workstations, client devices with display units, portable electronic devices with display units, network enabled computing devices, interactive network enabled communication devices, gaming devices with display units, televisions, web browsers, portable media players, theater systems, any entertainment system, any other suitable computing equipment with a display unit, combinations of multiple pieces of computing equipment, etc. In an embodiment, the user device 601 and the viewer devices 608 and 609 can be hybrid devices that combine the functionality of multiple devices. Examples of a hybrid electronic device comprise a cellular telephone that includes media player functionality, a gaming device that includes a wireless communications capability, a cellular telephone that includes game and electronic mail (email) functions, and a portable device that receives email, supports mobile telephone calls, has music player functionality, and supports web browsing. In an embodiment, computing equipment is used to implement applications such as media playback applications, for example, iTunes® from Apple Inc., a web browser, a mapping application, an electronic mail (email) application, a calendar application, etc. The user device 601, the viewer devices 608 and 609, and the COSS 508 are computer systems that are programmable using a high level computer programming language. In an embodiment, the ICOSS 500 is implemented on the user device 601 and each of the viewer devices 608 and 609 in entirety using programmed and purposeful hardware. In another embodiment, the ICOSS 500 is implemented on the COSS 508 in entirety using programmed and purposeful hardware.

The network 607 is, for example, the internet, an intranet, a wired network, a wireless network, a network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks. In an embodiment, the interactive content overlay and streaming system (ICOSS) 500 is accessible to a user, for example, through a broad spectrum of technologies and devices such as cellular phones, tablet computing devices, etc., with access to the internet.

The user device 601 comprises a non-transitory computer readable storage medium, for example, a memory unit 602 for storing program instructions, applications, and data, at least one processor 603, a network interface 604, a data bus 605, and a display unit 606. In an embodiment, each of the viewer devices 608 and 609 is a user device comprising the processor 603, the memory unit 602, the network interface 604, and the display unit 606 that displays the graphical user interface (GUI) 606a rendered by the interactive content overlay and streaming application (ICOSA) 501. Similar to the implementation of the ICOSA 501 on the user device 601, the ICOSA 501 is also implemented on each of the viewer devices 608 and 609. The non-transitory computer readable storage medium, for example, the memory unit 602 is communicatively coupled to the processor 603 and is configured to store computer program instructions defined by the modules, for example, 503, 507, 522, 523, 524, 525, etc., of the ICOSA 501. The ICOSA 501 is installed and stored in the memory unit 602 of the user device 601 and each of the viewer devices 608 and 609. The processor 603 is configured to execute the computer program instructions defined by the modules 503, 507, 522, 523, 524, 525, etc., of the ICOSA 501. The network interface 604 enables connection of the ICOSA 501 in the user device 601 and each of the viewer devices 608 and 609 to the network 607. The data bus 605 permits communications between the modules, for example, 602, 603, 604, 606, etc., of the user device 601 and each of the viewer devices 608 and 609. The display unit 606 comprises, for example, a video display, a liquid crystal display, a plasma display, an organic light emitting diode (OLED) based display, etc. The display unit 606 displays the GUI 606a provided by the ICOSA 501. The display unit 606, via the GUI 606a, displays information, displays interfaces, user interface elements such as swipable arrows, icons, search boxes, etc., for example, for selecting content data streams to be rendered on the control panels of the interactive space editor rendered by the ICOSA 501, etc. The ICOSA 501 renders the GUI 606a on the display unit 606 to receive user inputs, for example, a selection of content data streams, a trigger for initiating recording of the user media content on the user device 601, etc. The GUI 606a is, for example, an online web interface, a web based downloadable application interface, a mobile based downloadable application interface, etc.

The content overlay and streaming server (COSS) 508 comprises a non-transitory computer readable storage medium, for example, a memory unit 521 for storing program instructions, applications, and data, at least one processor 515, a data bus 516, a network interface 517, an input/output (I/O) controller 518, a fixed media drive 519 such as a hard drive, a removable media drive 520 for receiving removable media, etc. The non-transitory computer readable storage media in the user device 601 and the COSS 508 refers to all computer readable media, for example, non-volatile media, volatile media, and transmission media, except for a transitory, propagating signal. Non-volatile media comprise, for example, solid state drives, optical discs or magnetic disks, and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to each of the processors 603 and 515.

The non-transitory computer readable storage medium, for example, the memory unit 521 is communicatively coupled to the processor 515 and is configured to store computer program instructions defined by the modules, for example, 511, 513, etc., of the content overlay and streaming server (COSS) 508. The modules, for example, 510, 511, and 513 of the COSS 508 are installed and stored in the memory unit 521 of the COSS 508. The memory units 602 and 521 of the user device 601 and the COSS 508 respectively are, for example, random access memories (RAMs) or another type of dynamic storage devices that store information and instructions for execution by the processors 603 and 515 of the user device 601 and the COSS 508 respectively. The memory units 602 and 521 also store temporary variables and other intermediate information used during execution of the instructions by the processors 603 and 515 respectively. The user device 601 and the COSS 508, each further comprises a read only memory (ROM) or another type of static storage device that stores static information and instructions for the processors 603 and 515 respectively. The processor 515 of the COSS 508 is configured to execute the computer program instructions defined by the modules 511, 513, etc., of the COSS 508. The data bus 516 of the COSS 508 permits communications between the modules, for example, 515, 517, 518, 519, 520, 521, etc., of the COSS 508. The network interface 517 of the COSS 508 enables connection of the COSS 508 to the network 607.

In an embodiment, the network interfaces 604 and 517 of the user device 601 and the content overlay and streaming server (COSS) 508 respectively are provided as interface cards also referred to as line cards. The network interfaces 604 and 517 comprise, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The I/O controller 518 of the COSS 508 controls input actions and output actions performed by the COSS 508.

The processors 603 and 515 of the user device 601 and the content overlay and streaming server (COSS) 508 respectively, refer to any one or more microprocessors, central processing unit (CPU) devices, finite state machines, computers, microcontrollers, digital signal processors, logic, a logic device, an user circuit, an application specific integrated circuit (ASIC), a field-programmable gate array (FPGA), a chip, etc., or any combination thereof, capable of executing computer programs or a series of commands, instructions, or state transitions. In an embodiment, each of the processors 603 and 515 is implemented as a processor set comprising, for example, a programmed microprocessor and a math or graphics co-processor. The processor 603 and 515 are selected, for example, from the Intel® processors such as the Itanium® microprocessor or the Pentium® processors, Advanced Micro Devices (AMD®) processors such as the Athlon® processor, UltraSPARC® processors, microSPARC® processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The interactive content overlay and streaming system (ICOSS) 500 disclosed herein is not limited to employing the processors 603 and 515. In an embodiment, the ICOSS 500 employs controllers or microcontrollers.

The modules for implementing the interactive content overlay and streaming system (ICOSS) 500 comprise an interactive space editor rendering module 522 deployed in the user device 601, the application programming interface (API) module 511 deployed in the content overlay and streaming server (COSS) 508, the media and event recorder 503 deployed in the user device 601, a content overlay module 523 deployed in the user device 601, the media processing module 513 deployed in the COSS 508, an upload manager 524 deployed in the user device 601, a playback manager 525 deployed in the user device 601, and the playback synchronizer 507 deployed in the user device 601. The interactive space editor rendering module 522, the media and event recorder 503, the content overlay module 523, the upload manager 524, the playback manager 525, and the playback synchronizer 507 constitute the interactive content overlay and streaming application (ICOSA) 501 on the user device 601. The ICOSA 501 is activated on the user device 601 via the GUI 606a on the display unit 606.

The interactive space editor rendering module 522 renders an interactive space editor with multiple content panels on the graphical user interface (GUI) 606a deployed on the user device 601. The content panels comprise links to content data streams from multiple content sources 610. The content overlay and streaming server (COSS) 508 communicates with the content sources 610 via the network 607. The application programming interface (API) module 511 in the COSS 508, in communication with the interactive content overlay and streaming application (ICOSA) 501 on the user device 601, receives a selection of the content data streams to be rendered on the content panels of the interactive space editor from the user device 601. The received selection of the content data streams is stored in an application database 526 on the user device 601 and the server database 510 on the COSS 508. When a request to record the user media content is received from the user device 601, the media and event recorder 503 records the user media content on the user device 601 while the selected content data streams are streamed on the GUI 606a. The API module 511 on the COSS 508 dynamically receives the user media content being recorded from the user device 601 and stores the dynamically received user media content in the server database 510. The recorded user media content is stored in the application database 526 in the user device 601.

The content overlay module 523 overlays the user media content being recorded on the selected content data streams being streamed. The content overlay module 523 and the interactive space editor rendering module 522 perform the functions of the viewer 506 disclosed in the detailed description of FIG. 5. The media and event recorder 503 then records content panel events and synchronization data on the user device 601 during the recording of the user media content. The recorded content panel events and the synchronization data are also stored in the application database 526. When a request for terminating the recording of the user media content is received from the user device 601, the media processing module 513, in communication with the interactive content overlay and streaming application (ICOSA) 501 on the user device 601, receives the recorded user media content, the recorded content panel events, and the recorded synchronization data stored in the application database 526 from the user device 601. The upload manager 524 uploads the recorded user media content, the recorded content panel events, and the recorded synchronization data to the content overlay and streaming server (COSS) 508 as disclosed in the detailed description of FIG. 2. The media processing module 513 then generates a content media object by processing the received user media content for providing access of the processed user media content and the selected content data streams through the generated content media object to the viewer devices 608 and 609. In an embodiment, the media processing module 513 stores the generated content media object in the persistent storage 514 to provide access of the processed user media content and the selected content data streams to the viewer devices 608 and 609 over the network 607. The media processing module 513 creates different formats of the received user media content and generates a thumbnail of the received user media content during the processing of the received user media content to generate the content media object.

When the generated content media object is accessed by the viewer devices 608 and 609 via the graphical user interface (GUI) 606a deployed on each of the viewer devices 608 and 609, the content overlay module 523 of the interactive content overlay and streaming application (ICOSA) 501 in each of the viewer devices 608 and 609 overlays the processed user media content and an interaction panel on the selected content data streams on the GUI 606a deployed on each of the viewer devices 608 and 609. The playback manager 525 streams the selected content data streams and the overlaid user media content and displays comments entered in the interaction panel from the viewer devices 608 and 609 via the GUI 606a deployed on each of the viewer devices 608 and 609 as disclosed in the detailed description of FIG. 3. The playback synchronizer 507 synchronizes the selected content data streams being streamed in real time with the overlaid user media content being streamed using the received content panel events and the received synchronization data. The playback synchronizer 507 also suspends the streaming of the overlaid user media content when the selected content data streams being streamed are buffering. The playback synchronizer 507 resumes the streaming of the overlaid user media content when the selected content data streams being streamed have buffered for the synchronization of the selected content data streams in real time with the overlaid user media content. In an embodiment, the media and event recorder 503 records the user media content on the user device 601, while the content overlay module 523 simultaneously overlays the user media content being recorded on the user device 601 and the interaction panel on live content data streams on the GUI 606a deployed on each of the viewer devices 608 and 609 as disclosed in the detailed description of FIG. 1B.

The application database 526 in the user device 601, the server database 510 in the content overlay and streaming server (COSS) 508, and the persistent storage 514 can be any storage area or medium that can be used for storing the selection of content data streams, the recorded user media content, the recorded content panel events, and the recorded synchronization data. In an embodiment, the application database 526, the server database 510, and the persistent storage 514 are external databases, for example, a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase™ database of the Apache Software Foundation, etc. In an embodiment, the application database 526, the server database 510, and the persistent storage 514 can also be a location on a file system. In another embodiment, the application database 526 and the server database 510 can be remotely accessed by the user device 601 and the COSS 508 respectively via the network 607. In another embodiment, the persistent storage 514 can be remotely accessed by the user device 601 and the COSS 508 via the network 607. In another embodiment, the application database 526, the server database 510, and the persistent storage 514 are configured as cloud based databases implemented in a cloud computing environment, where computing resources are delivered as a service over the network 607.

Computer applications and programs are used for operating the interactive content overlay and streaming application (ICOSA) 501 on the user device 601 and each of the viewer devices 608 and 609, and for operating the content overlay and streaming server (COSS) 508. The programs of the application programming interface (API) module 511 and the media processing module 513 are loaded onto the fixed media drive 519 and into the memory unit 521 of the COSS 508 via the removable media drive 520. In an embodiment, the computer applications and programs are loaded directly on the COSS 508 via the network 607. Similarly, the programs of the modules, for example, 503, 507, 522, 523, 524, 525, etc., of the ICOSA 501 are loaded onto a fixed media drive (not shown) and into the memory unit 602 of the user device 601 and each of the viewer devices 608 and 609 via a removable media drive (not shown). In an embodiment, the computer applications and programs are loaded directly on the user device 601 and the viewer devices 608 and 609 via the network 607.

Each of the processors 603 and 515 execute an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., the Palm OS®, the Solaris operating system developed by Sun Microsystems, Inc., etc. The content overlay and streaming server (COSS) 508, the user device 601, and each of the viewer devices 608 and 609 employ their respective operating systems for performing multiple tasks. For example, the operating system of the COSS 508 is responsible for management and coordination of activities and sharing of resources of the COSS 508. The operating system further manages security of the COSS 508, peripheral devices connected to the COSS 508, and network connections. The operating system employed on the COSS 508 recognizes, for example, inputs provided by the user via the user device 601, files, and directories stored locally on the fixed media drive 519. The operating systems on the COSS 508 and the user device 601 execute different programs using the processors 603 and 515 respectively. The processors 603 and 515 and the operating systems of the user device 601 and the COSS 508 respectively, together define a computer platform for which application programs in high level programming languages are written.

The processor 603 of the user device 601 retrieves instructions defined by the interactive space editor rendering module 522, the media and event recorder 503, the content overlay module 523, the upload manager 524, the playback manager 525, and the playback synchronizer 507 in the memory unit 602 of the user device 601, for performing respective functions disclosed above. The processor 515 of the content overlay and streaming server (COSS) 508 retrieves instructions defined by the application programming interface (API) module 511 and the media processing module 513 in the memory unit 521 of the COSS 508, for performing respective functions disclosed above. The processor 603 retrieves instructions for executing the modules, for example, 503, 507, 522, 523, 524, 525, etc., of the user device 601 from the memory unit 602. The processor 515 retrieves instructions for executing the modules, for example, 511, 513, etc., of the COSS 508 from the memory unit 521. A program counter determines the location of the instructions in each of the memory units 602 and 521. The program counter stores a number that identifies the current position in the program of each of the modules, for example, 503, 507, 522, 523, 524, 525, etc., and the modules, for example, 511, 513, etc., of the user device 601 and the COSS 508 respectively. The instructions fetched by the processors 603 and 515 from the memory units 602 and 521 respectively, after being processed are decoded. The instructions are stored in an instruction register in each of the processors 603 and 515. After processing and decoding, the processors 603 and 515 execute the instructions, thereby performing one or more processes defined by those instructions.

At the time of execution, the instructions stored in the instruction register are examined to determine the operations to be performed. The processors 603 and 515 then perform the specified operations. The operations comprise arithmetic operations and logic operations. The operating system performs multiple routines for performing a number of tasks required to assign the memory units 602 and 521 for execution of the modules, for example, 503, 507, 522, 523, 524, 525, etc., and the modules, for example, 511, 513, etc., on the user device 601 and the content overlay and streaming server (COSS) 508 respectively, for implementing the interactive content overlay and streaming system (ICOSS) 500. The tasks performed by the operating system comprise, for example, assigning memory to the modules, for example, 503, 507, 522, 523, 524, 525, etc., and the modules, for example, 511, 513, etc., on the user device 601 and the COSS 508 respectively, and to data used by the user device 601 and the COSS 508 respectively, moving data between the memory units 602 and 521 and disk units, and handling input/output operations. The operating system performs the tasks on request by the operations and after performing the tasks, the operating system transfers the execution control back to the processors 603 and 515. The processors 603 and 515 continue the execution to obtain one or more outputs. The outputs of the execution of the modules, for example, 503, 507, 522, 523, 524, 525, etc., and the modules, for example, 511, 513, etc., on the user device 601 and the COSS 508 respectively, for implementing the ICOSS 500 are displayed to the user on the graphical user interface (GUI) 606a of the user device 601 and each of the viewer devices 608 and 609.

The non-transitory computer readable storage medium disclosed herein stores computer program codes comprising instructions executable by the processors 603 and 515 for overlaying user media content on content data streams and synchronizing the content data streams in real time with the overlaid user media content. The computer program codes comprise a first computer program code for rendering an interactive space editor with multiple content panels on the graphical user interface (GUI) 606a deployed on the user device 601; a second computer program code for receiving a selection of the content data streams to be rendered on the content panels of the interactive space editor from the user device 601; a third computer program code for recording the user media content on the user device 601 using the media and event recorder 503 of the user device 601, while streaming the selected content data streams on the GUI 606a, when a request to record the user media content is received from the user device 601; a fourth computer program code for overlaying the user media content being recorded on the selected content data streams being streamed; a fifth computer program code for recording content panel events and synchronization data on the user device 601 during the recording of the user media content; a sixth computer program code for receiving the recorded user media content, the recorded content panel events, and the recorded synchronization data from the user device 601, when a request for terminating the recording of the user media content is received from the user device 601; a seventh computer program code for generating a content media object by processing the received user media content for providing access of the processed user media content and the selected content data streams through the generated content media object to the viewer devices 608 and 609; an eighth computer program code for overlaying the processed user media content and an interaction panel on the selected content data streams on the GUI 606a deployed on each of the viewer devices 608 and 609 when the generated content media object is accessed by the viewer devices 608 and 609 via the GUI 606a deployed on each of the viewer devices 608 and 609; a ninth computer program code for streaming the selected content data streams with the overlaid user media content, and displaying comments entered in the interaction panel from the viewer devices 608 and 609 via the GUI 606a deployed on each of the viewer devices 608 and 609; and a tenth computer program code for synchronizing the selected content data streams being streamed in real time with the overlaid user media content being streamed using the received content panel events and the received synchronization data.

In an embodiment, the tenth computer program code comprises an eleventh computer program code for suspending the streaming of the overlaid user media content when the selected content data streams being streamed are buffering, and a twelfth computer program code for resuming the streaming of the overlaid user media content when the selected content data streams being streamed have buffered for the synchronization of the selected content data streams in real time with the overlaid user media content. The computer program codes further comprise one or more additional computer program codes for performing additional steps that may be required and contemplated for overlaying user media content on content data streams and synchronizing the content data streams in real time with the overlaid user media content. In an embodiment, a single piece of computer program code comprising computer executable instructions performs one or more steps of the computer implemented method disclosed herein for overlaying user media content on content data streams and synchronizing the content data streams in real time with the user media content. The computer program codes comprising computer executable instructions are embodied on the non-transitory computer readable storage medium. The processors 603 and 515 of the user device 601 and the content overlay and streaming server (COSS) 508 retrieve their respective computer executable instructions and execute them. When the computer executable instructions are executed by the processors 603 and 515, the computer executable instructions cause the processors 603 and 515 to perform the steps of the computer implemented method for overlaying user media content on content data streams and synchronizing the content data streams in real time with the overlaid user media content.

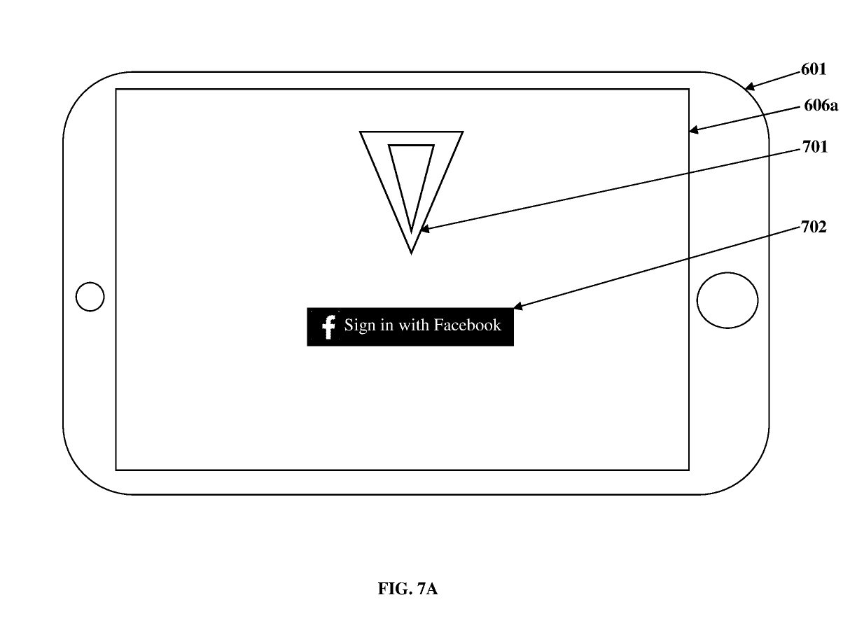

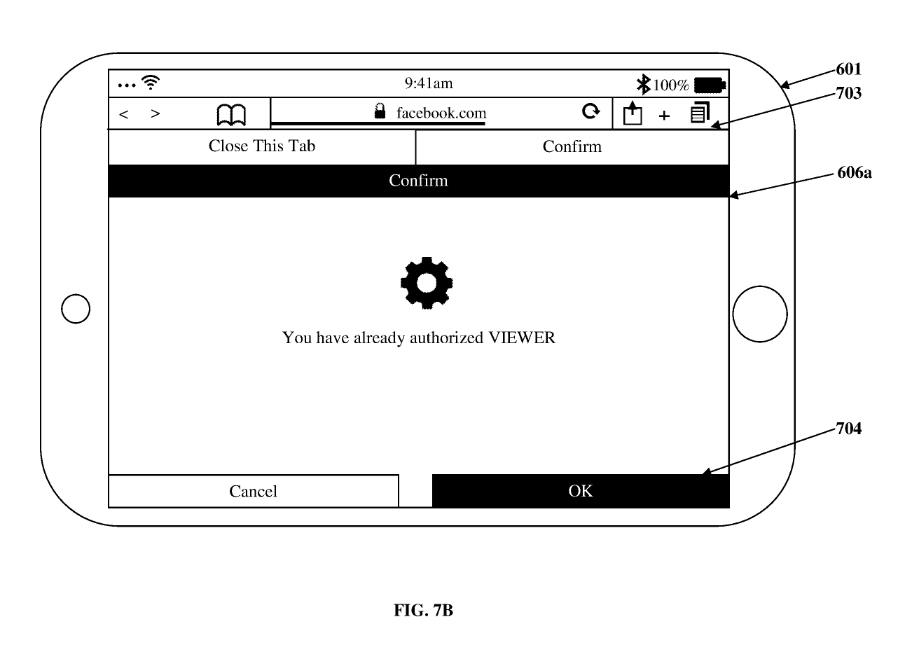

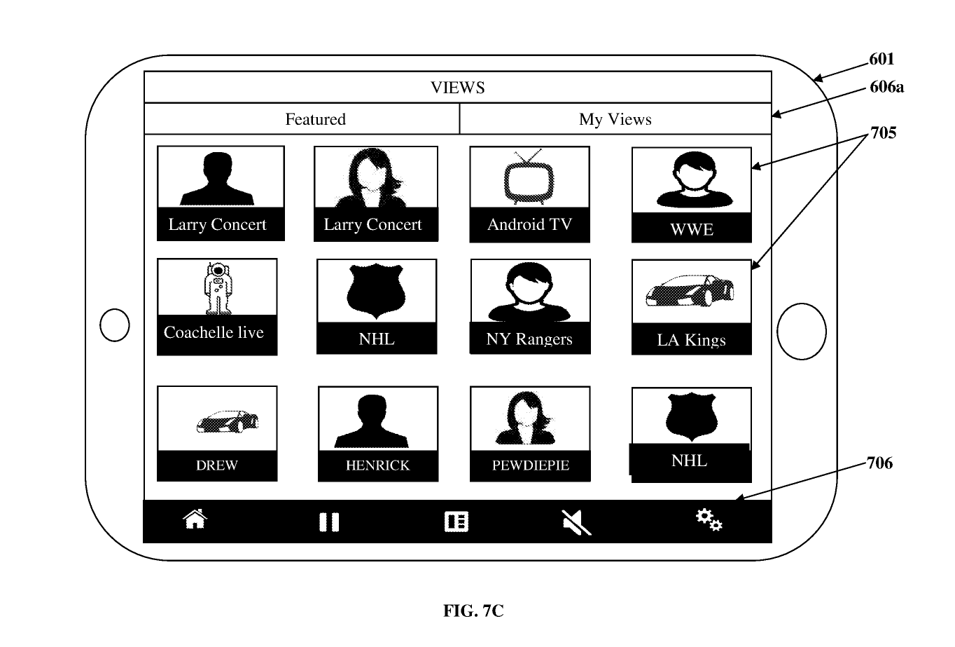

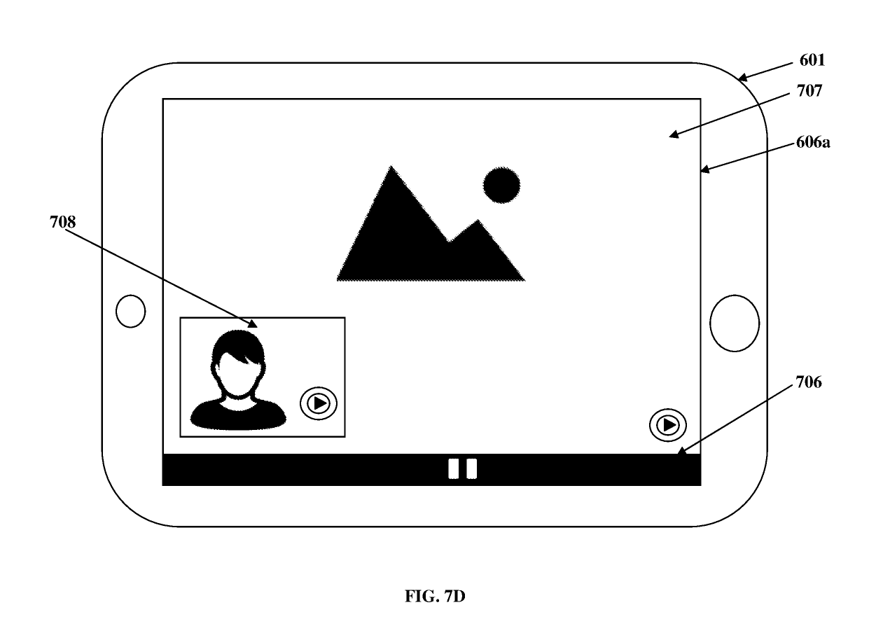

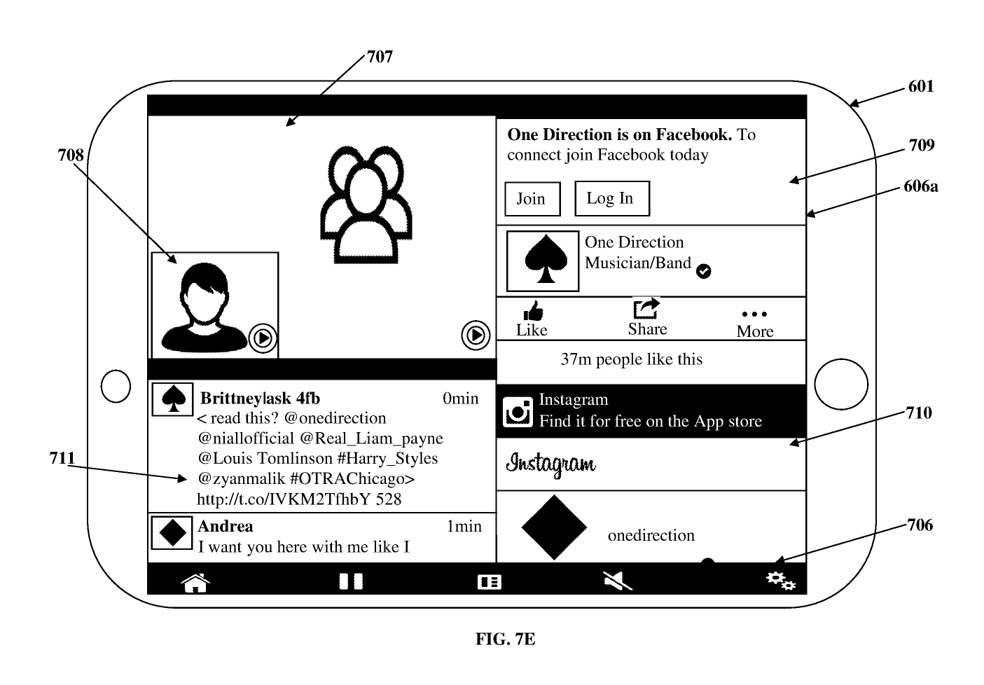

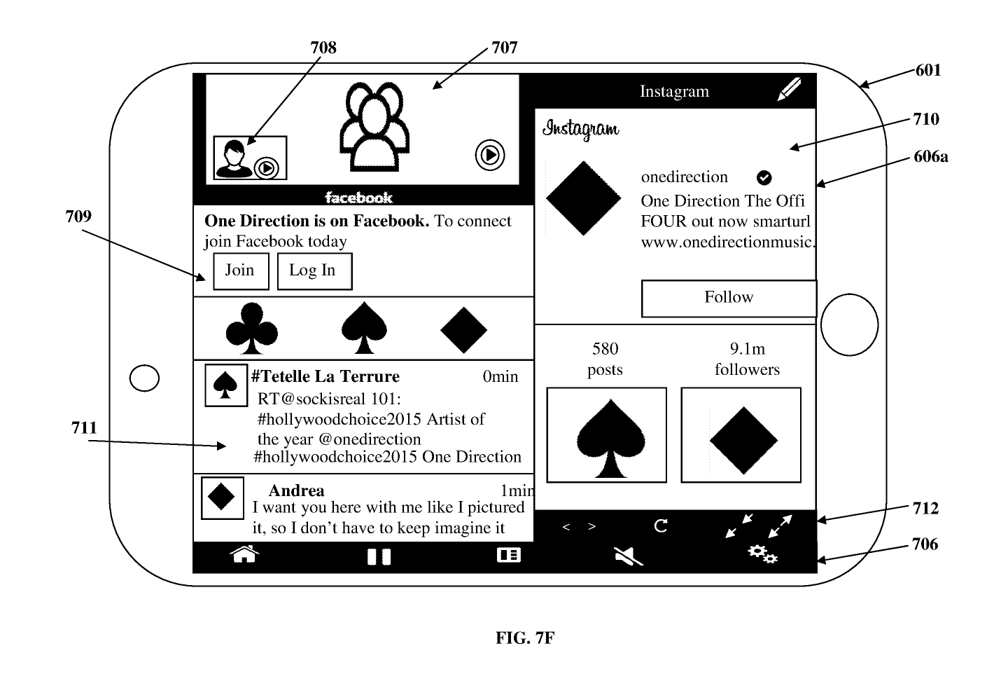

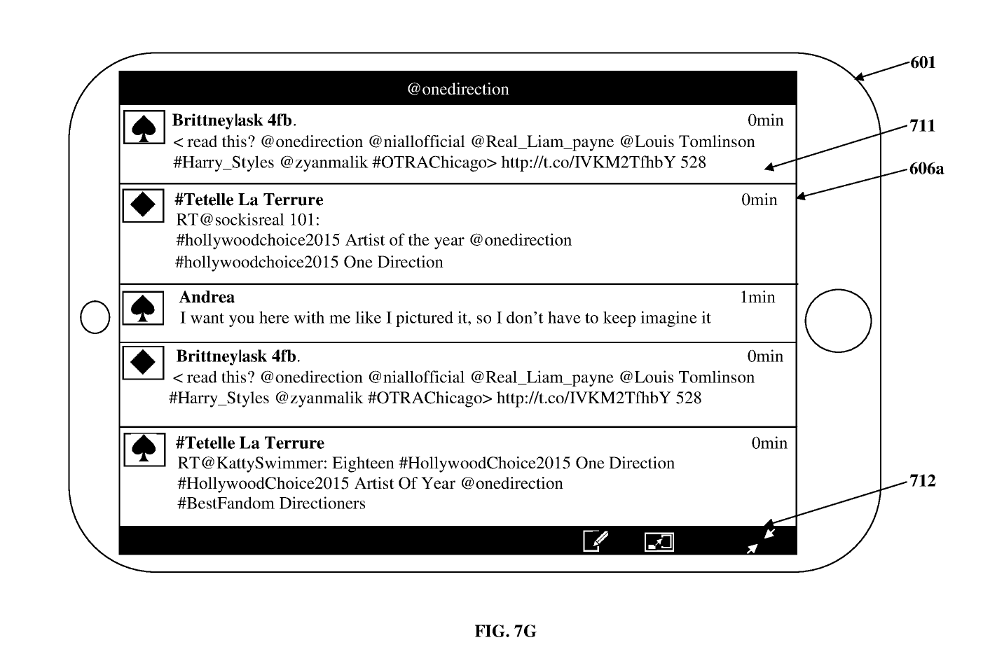

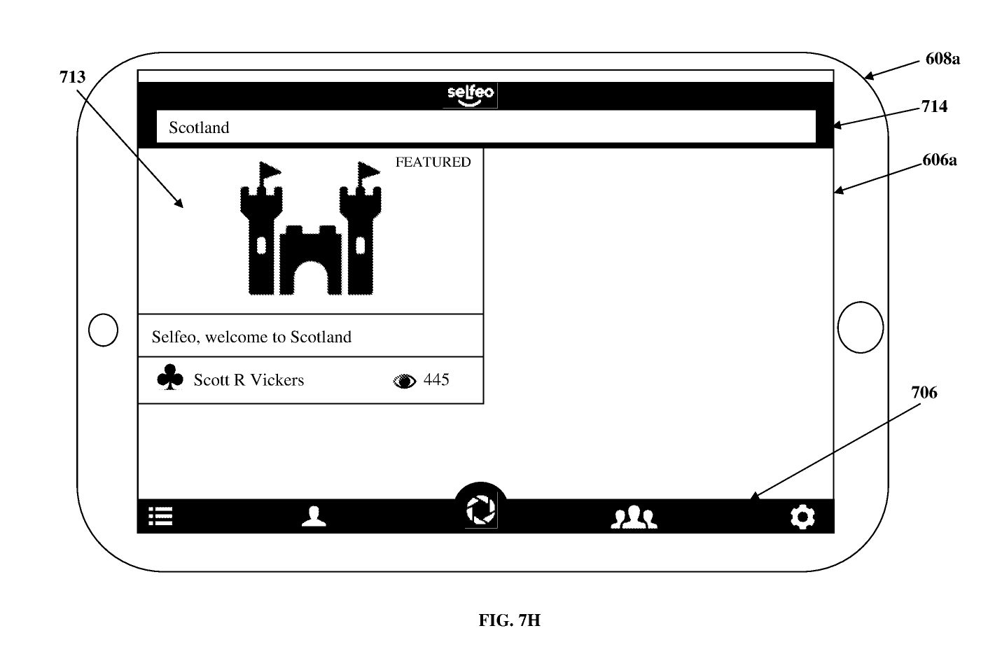

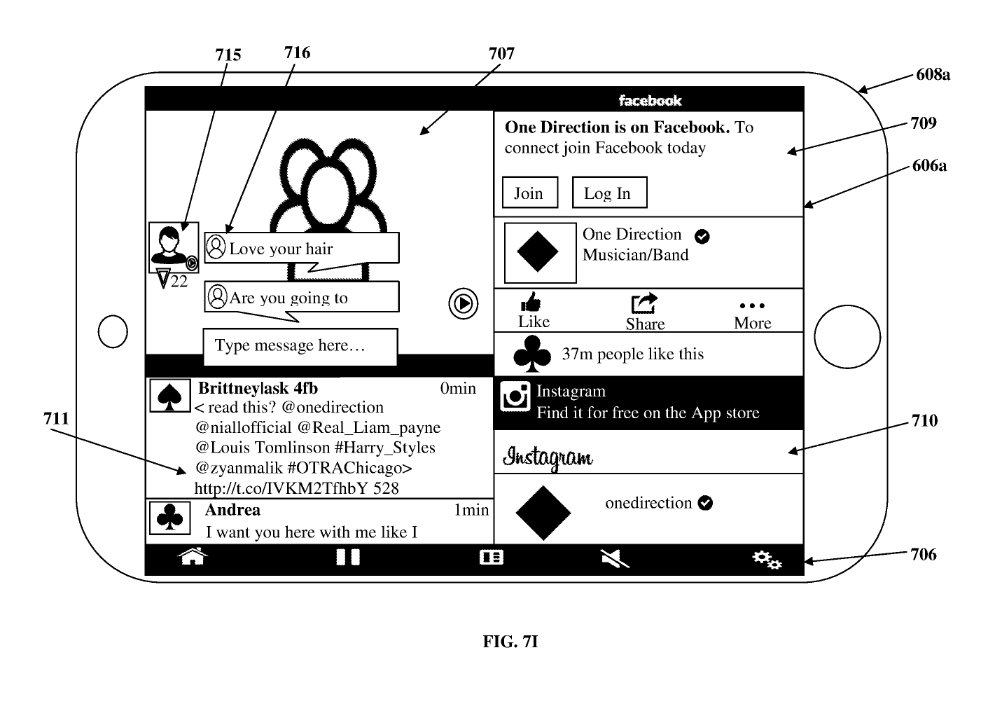

FIGS. 7A-7B exemplarily illustrate screenshots of the graphical user interface (GUI) 606a provided by the interactive content overlay and streaming application (ICOSA) 501 exemplarily illustrated in FIGS. 5-6, installed on a user device 601 for accessing the interactive content overlay and streaming system (ICOSS) 500 exemplarily illustrated in FIG. 5. FIG. 7A exemplarily illustrates the GUI 606a rendered on the user device 601 positioned in a landscape orientation. The GUI 606a displays an icon 701 for the ICOSS 500 and a sign in link 702 to allow a user to sign into the ICOSS 500 through a social networking platform, for example, Facebook®. FIG. 7B exemplarily illustrates the GUI 606a redirecting a user of the user device 601 to a webpage 703 of Facebook® that authenticates the user to access the ICOSS 500 using Facebook® credentials. The user clicks on an acceptance icon 704 to confirm the sign in.

FIG. 7C exemplarily illustrates a screenshot of the graphical user interface (GUI) 606a provided by the interactive content overlay and streaming application (ICOSA) 501 exemplarily illustrated in FIGS. 5-6, installed on the user device 601 for selecting content data streams. As exemplarily illustrated in FIG. 7C, the GUI 606a displays thumbnails 705 of the content data streams for selection of the content data streams to be rendered on content panels and for selection of a view with a desired layout of the content panels, by the user of the user device 601 as disclosed in the detailed description of FIG. 1A. The GUI 606a further displays a navigation bar 706 for navigating the ICOSA 501. The navigation bar 706 comprises icons for navigating to a home screen of the ICOSA 501, playing or pausing a video, configuring views, muting audio of the ICOSA 501, and navigating to a settings screen of the ICOSA 501.

FIG. 7D exemplarily illustrates a screenshot of the graphical user interface (GUI) 606a provided by the interactive content overlay and streaming application (ICOSA) 501 exemplarily illustrated in FIGS. 5-6, installed on the user device 601, showing raw user media content 708 being recorded, overlaid on a selected content data stream being streamed. The GUI 606a renders a video stream 707 in a landscape orientation with an overlay of the raw user media content 708 being recorded when a user of the user device 601 selects the video stream 707 as the content data stream and triggers a record function of the ICOSA 501 as disclosed in the detailed description of FIG. 1A. The GUI 606a further displays the navigation bar 706 comprising a pause icon to suspend the recording of the raw user media content 708.

FIGS. 7E-7G exemplarily illustrate screenshots of the graphical user interface (GUI) 606a provided by the interactive content overlay and streaming application (ICOSA) 501 exemplarily illustrated in FIGS. 5-6, installed on the user device 601, showing the raw user media content 708 being recorded, overlaid on a selected content data stream in a content panel, and content panel events being recorded during the recording of the raw user media content 708. FIG. 7E exemplarily illustrates the video stream 707 with the overlaid raw user media content 708 in a content panel on the GUI 606a of the ICOSA 501 during recording of the raw user media content 708. The GUI 606a displays other content panels in a view selected by a user of the user device 601. For example, the GUI 606a displays comprises a Facebook® content panel 709, an Instagram® content panel 710 with a content data stream of Instagram® of Instagram LLC, and a communication interface session content panel 711. Moreover, the GUI 606a displays the navigation bar 706. FIG. 7F exemplarily illustrates the GUI 606a shown in FIG. 7E, with the Instagram® content panel 710 expanded to cover about half of the GUI 606a. The GUI 606a also displays the other content panels 707, 709, and 711 shown in FIG. 7E, in a different view as exemplarily illustrated in FIG. 7F. The other content panels comprise the video stream 707 with the overlaid raw user media content 708, the Facebook® content panel 709, and the communication interface session content panel 711. The GUI 606a also displays a content panel handle bar 712 with options to resize a content panel, and navigate and refresh the content data stream in the content panel. FIG. 7G exemplarily illustrates the GUI 606a with the communication interface session content panel 711 expanded to cover the GUI 606a using content panel resize options provided in the content panel handle bar 712.

FIG. 7H exemplarily illustrates a screenshot of the graphical user interface (GUI) 606a provided by the interactive content overlay and streaming application (ICOSA) 501, exemplarily illustrated in FIGS. 5-6, installed on a viewer device 608a for accessing a content media object 713 generated by the interactive content overlay and streaming system (ICOSS) 500 exemplarily illustrated in FIG. 5. The GUI 606a exemplarily illustrated in FIG. 7H, displays the content media object 713, a content media object search bar 714, and the navigation bar 706. The content media object 713 comprises links to the processed user media content and the selected content data streams on the content overlay and streaming server (COSS) 508 exemplarily illustrated in FIGS. 5-6, as disclosed in the detailed description of FIG. 1A. The content media object search bar 714 facilitates a search for content media objects on the COSS 508 from the ICOSA 501 installed on the viewer device 608a. The navigation bar 706 provides options relevant to the section of the ICOSA 501 displayed on the GUI 606a. The navigation bar 706 comprises options for navigating to other sections of the ICOSA 501, recording raw user media content 708 exemplarily illustrated in FIG. 7D, searching for processed user media content obtained from the raw user media content 708 uploaded by the user device 601 exemplarily illustrated in FIGS. 7A-7G, and navigating to settings of the ICOSA 501.

FIG. 7I exemplarily illustrates a screenshot of the graphical user interface (GUI) 606a provided by the interactive content overlay and streaming application (ICOSA) 501 exemplarily illustrated in FIGS. 5-6, installed on the viewer device 608a, showing the processed user media content 715 and an interaction panel 716 overlaid on a selected content data stream in a content panel. Consider an example where a user of the viewer device 608a selects the content media object 713 exemplarily illustrated in FIG. 7H. The ICOSA 501 starts streaming the processed user media content 715, the interaction panel 716, and the selected content data stream, for example, a video stream 707, from the content overlay and streaming server (COSS) 508 exemplarily illustrated in FIGS. 5-6, as disclosed in the detailed description of FIG. 1A. The processed media content 715 and the interaction panel 716 are overlaid on the video stream 707. The interaction panel 716 displays comments of users of the viewer device 608a and other viewer devices 609 exemplarily illustrated in FIG. 6, that are accessing the processed user media content 715 and the video stream 707 linked by the content media object 713. The GUI 606a also displays content data streams other than the video stream 707 in the Facebook® content panel 709, the Instagram® content panel 710, and the communication interface session content panel 711, and the navigation bar 706 as exemplarily illustrated in FIG. 7I.

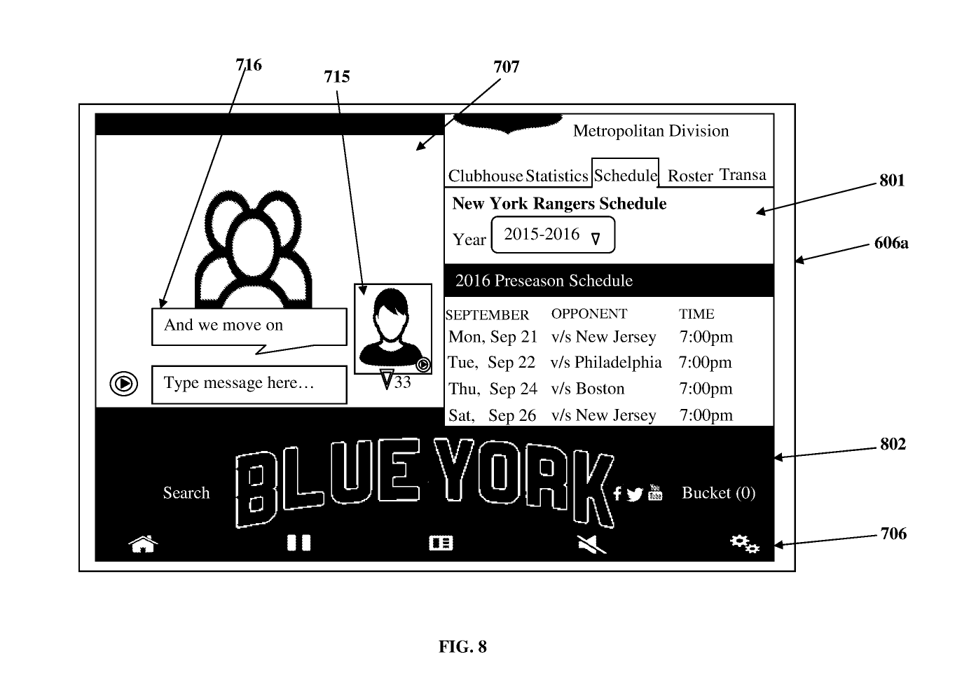

FIG. 8 exemplarily illustrates a screenshot of the graphical user interface (GUI) 606a provided by the interactive content overlay and streaming application (ICOSA) 501 exemplarily illustrated in FIGS. 5-6, installed on the viewer device 608a, showing the processed user media content 715 and the interaction panel 716 overlaid on different content data streams in content panels. The GUI 606a renders the video stream 707 with the processed user media content 715 and the interaction panel 716 overlaid on the video stream 707. The GUI 606a displays a sports score content panel 801, a sports search content panel 802 with content data streams related to sports, and the navigation bar 706 as exemplarily illustrated in FIG. 8.

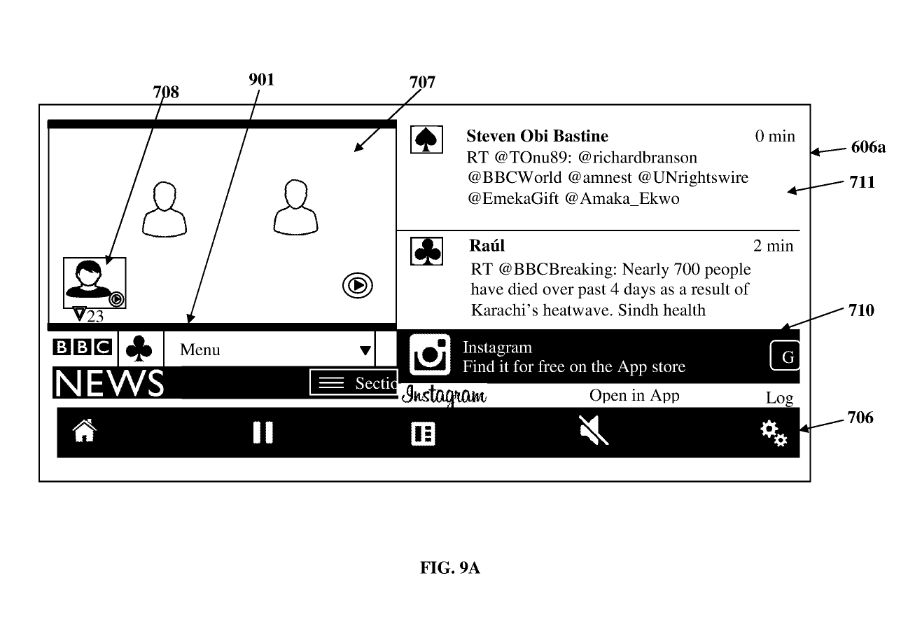

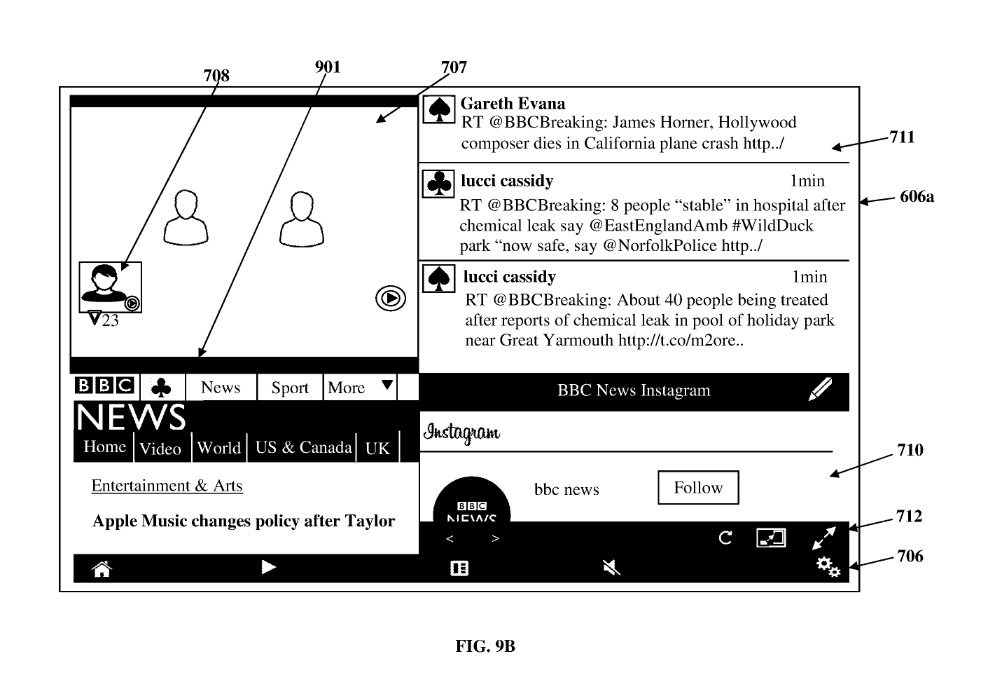

FIGS. 9A-9B exemplarily illustrate screenshots of the graphical user interface (GUI) 606a provided by the interactive content overlay and streaming application (ICOSA) 501 exemplarily illustrated in FIGS. 5-6, installed on a smartphone and a tablet computing device respectively, in a landscape orientation, showing the raw user media content 708 being recorded, overlaid on selected content data streams in content panels arranged in a first layout. The GUI 606a renders the video stream 707 with the raw user media content 708 being recorded, overlaid on the video stream 707 in one content panel. The GUI 606a also displays content panels with the selected content data streams other than the video stream 707. For example, the GUI 606a displays a BBC® content panel 901 with BBC® News of The British Broadcasting Corporation, the Instagram® content panel 710, and the communication interface session content panel 711. The content panels are laid out on the GUI 606a in the first layout with a view comprising the four content panels in a first grid pattern. The GUI 606a also displays the navigation bar 706 as exemplarily illustrated in FIGS. 9A-9B, and the content panel handle bar 712 as exemplarily illustrated in FIG. 9B.

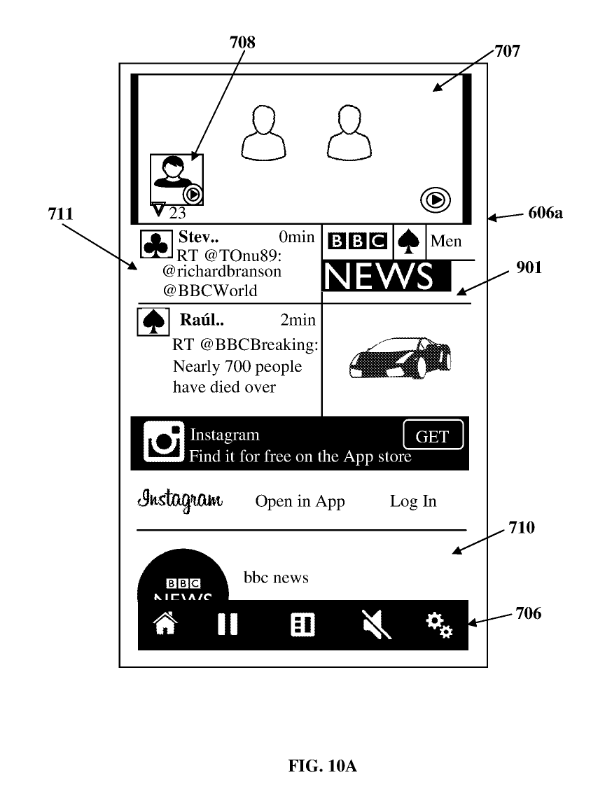

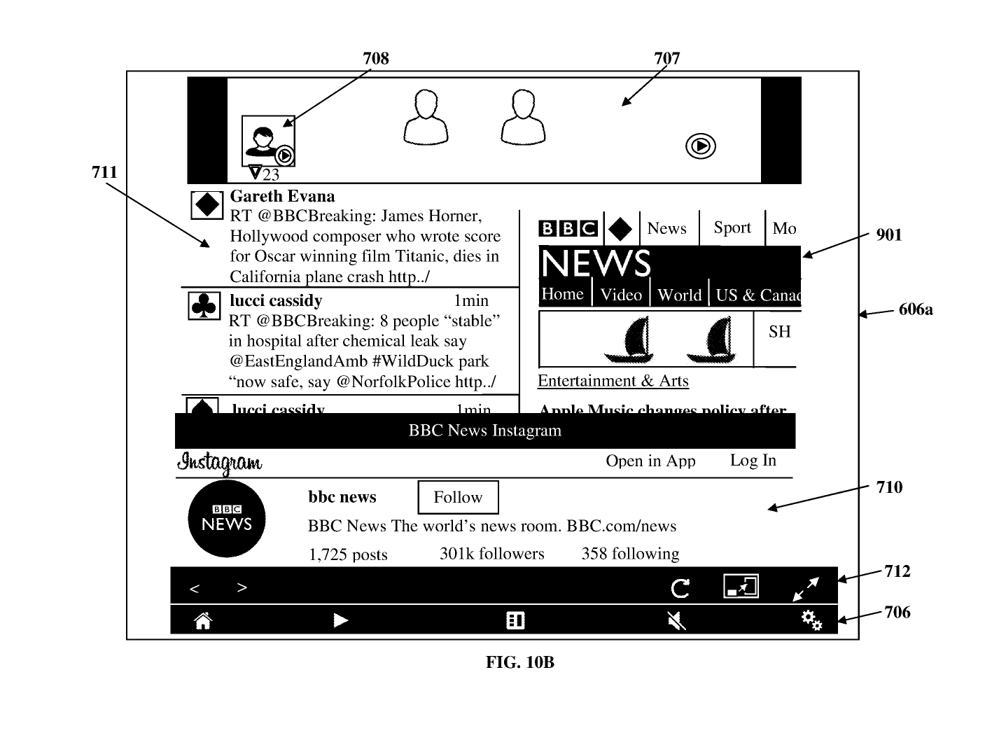

FIGS. 10A-10B exemplarily illustrate screenshots of the graphical user interface (GUI) 606a provided by the interactive content overlay and streaming application (ICOSA) 501 exemplarily illustrated in FIGS. 5-6, installed on a smartphone and a tablet computing device respectively, in a portrait orientation, showing the raw user media content 708 being recorded, overlaid on selected content data streams in content panels arranged in a second layout. The GUI 606a renders the video stream 707 with the raw user media content 708 being recorded, overlaid on the video stream 707 in one content panel. The GUI 606a also displays content panels with the selected content data streams other than the video stream 707. For example, the GUI 606a displays the BBC® content panel 901, the Instagram® content panel 710, and the communication interface session content panel 711. The content panels are laid out on the GUI 606a in the second layout with a view comprising the four content panels in a second grid pattern. The GUI 606a also displays the navigation bar 706 as exemplarily illustrated in FIGS. 10A-10B, and the content panel handle bar 712 as exemplarily illustrated in FIG. 10B.

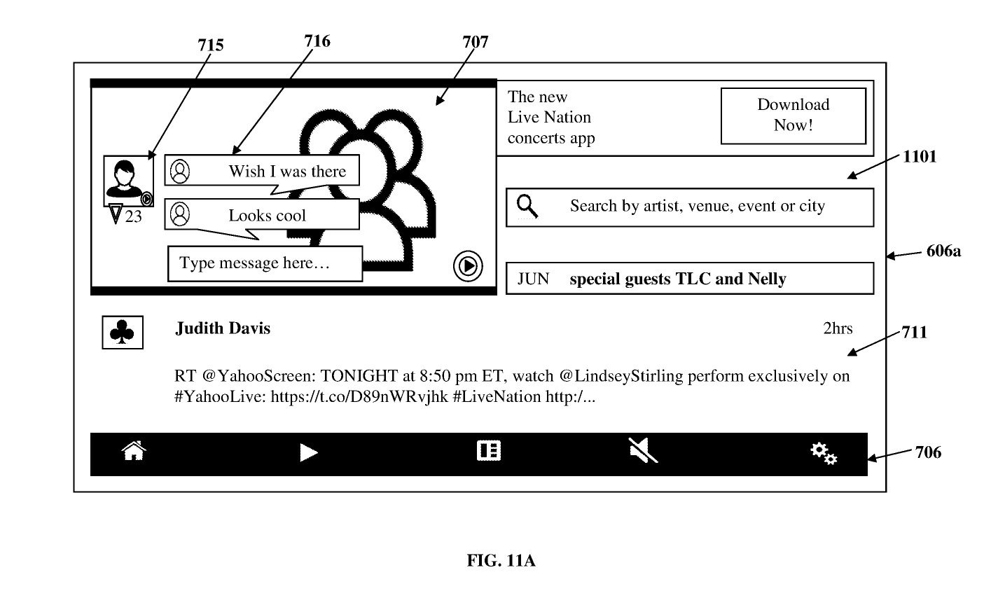

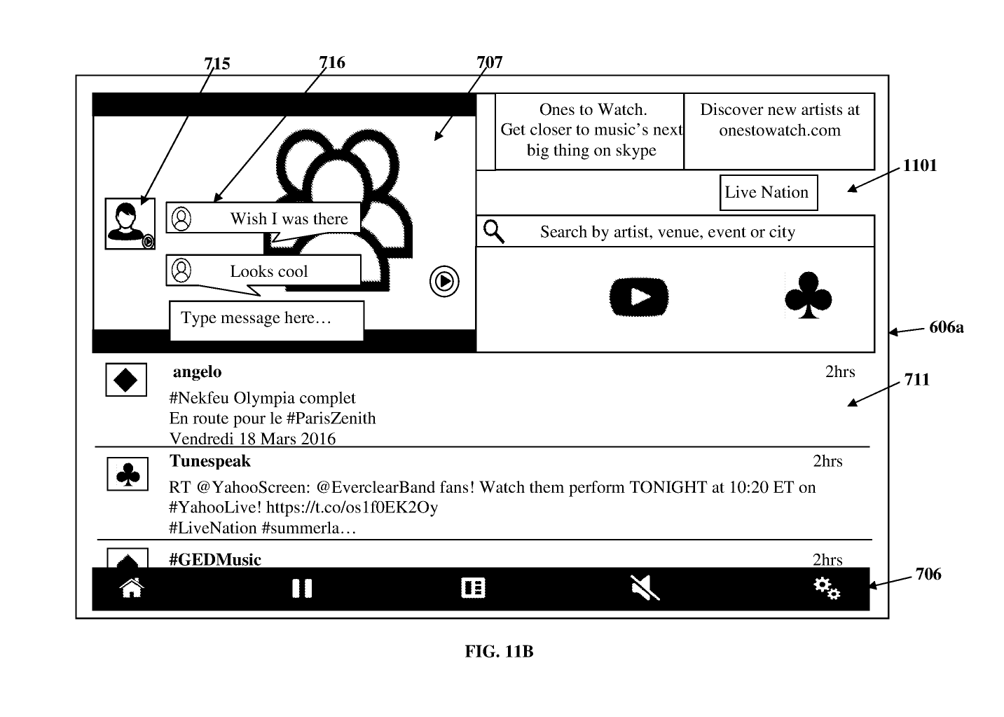

FIGS. 11A-11B exemplarily illustrate screenshots of the graphical user interface (GUI) 606a provided by the interactive content overlay and streaming application (ICOSA) 501 exemplarily illustrated in FIGS. 5-6, installed on a smartphone and a tablet computing device respectively, in a landscape orientation, showing processed user media content 715 and an interaction panel 716 overlaid on selected content data streams in content panels arranged in a third layout. The GUI 606a renders the video stream 707 with the processed user media content 715 being streamed and the interaction panel 716, overlaid on the video stream 707. The GUI 606a also displays content panels with the selected content data streams other than the video stream 707. For example, the GUI 606a displays a Live Nation® content panel 1101 with a content data stream from Live Nation® of Live Nation Worldwide, Inc., and the communication interface session content panel 711. The content panels are laid out on the GUI 606a in the third layout with a view comprising the three content panels in a third grid pattern. The GUI 606a also displays the navigation bar 706 as exemplarily illustrated in FIGS. 11A-11B.

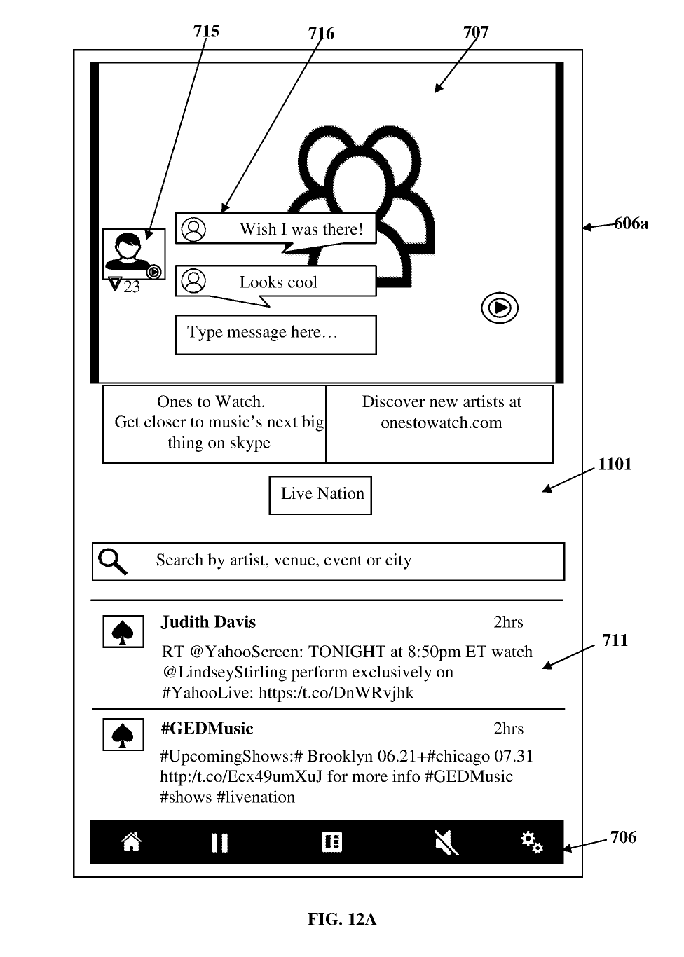

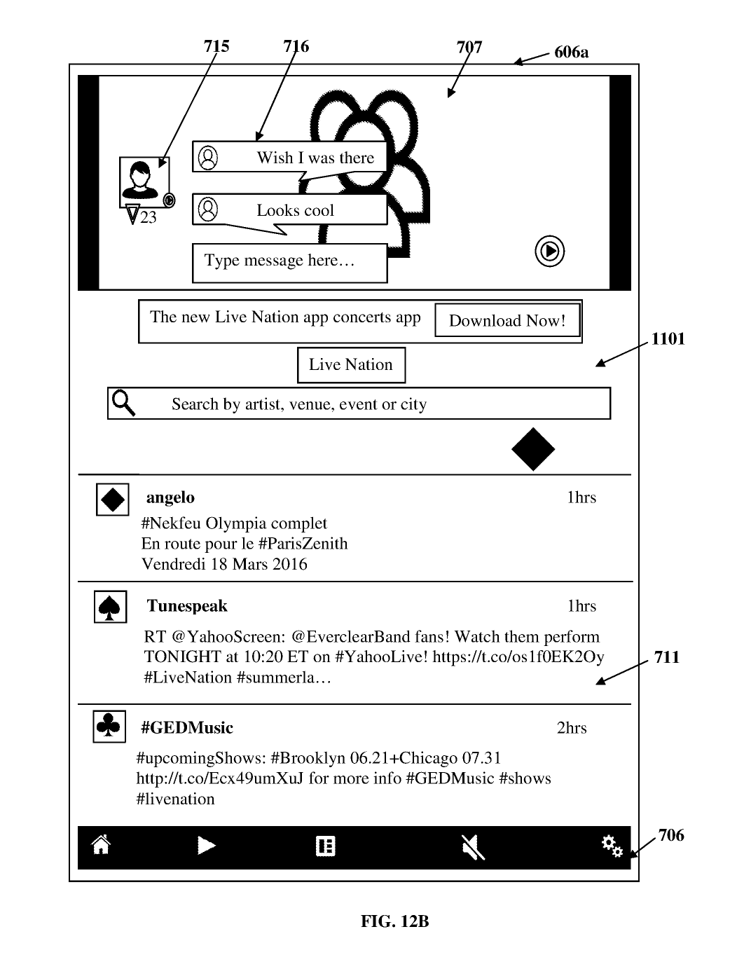

FIGS. 12A-12B exemplarily illustrate screenshots of the graphical user interface (GUI) 606a provided by the interactive content overlay and streaming application (ICOSA) 501 exemplarily illustrated in FIGS. 5-6, installed on a smartphone and a tablet computing device respectively, in a portrait orientation, showing the processed user media content 715 and the interaction panel 716 overlaid on selected content data streams in content panels arranged in a fourth layout. The GUI 606a renders the video stream 707 with the processed user media content 715 being streamed and the interaction panel 716, overlaid on the video stream 707. The GUI 606a also displays content panels with the selected content data streams other than the video stream 707. For example, the GUI 606a displays comprise the Live Nation® content panel 1101 and the communication interface session content panel 711. The content panels are laid out on the GUI 606a in the fourth layout with a view comprising the three content panels in a fourth grid pattern. The GUI 606a also displays the navigation bar 706 as exemplarily illustrated in FIGS. 12A-12B.

It will be readily apparent in different embodiments that the various methods, algorithms, and computer programs disclosed herein are implemented on non-transitory computer readable storage media appropriately programmed for computing devices. The non-transitory computer readable storage media participate in providing data, for example, instructions that are read by a computer, a processor or a similar device. In different embodiments, the “non-transitory computer readable storage media” also refer to a single medium or multiple media, for example, a centralized database, a distributed database, and/or associated caches and servers that store one or more sets of instructions that are read by a computer, a processor or a similar device. The “non-transitory computer readable storage media” also refer to any medium capable of storing or encoding a set of instructions for execution by a computer, a processor or a similar device and that causes a computer, a processor or a similar device to perform any one or more of the methods disclosed herein. Common forms of the non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in a number of manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise Java®, JavaScript®, C#, Scala® of Scala, Inc., etc. Other object-oriented, functional, scripting, and/or logical programming languages can also be used. In an embodiment, the computer program codes or software programs are stored on or in one or more mediums as object code. In another embodiment, various aspects of the computer implemented method and system 600 disclosed herein and exemplarily illustrated in FIG. 6, are implemented in a non-programmed environment comprising documents created, for example, in a hypertext markup language (HTML), an extensible markup language (XML), or other format that render aspects of the graphical user interface (GUI) 606a exemplarily illustrated in FIG. 6, or perform other functions, when viewed in a visual area or a window of a browser program. In another embodiment, various aspects of the computer implemented method and system 600 disclosed herein are implemented as programmed elements, or non-programmed elements, or any suitable combination thereof.

Where databases are described such as the server database 510, the application database 526, and the persistent storage 514, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. Object methods or behaviors of a database can be used to implement various processes such as those disclosed herein. In another embodiment, the databases are, in a known manner, stored locally or remotely from a device that accesses data in such a database. In embodiments where there are multiple databases in the computer implemented system 600, the databases are integrated to communicate with each other for enabling simultaneous updates of data linked across the databases, when there are any updates to the data in one of the databases.

The computer implemented method and system 600 disclosed herein can be configured to work in a network environment comprising one or more computers that are in communication with one or more devices via the network 607 exemplarily illustrated in FIG. 6. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to the network 607. Each of the computers and the devices executes an operating system, examples of which are disclosed above. While the operating system may differ depending on the type of computer, the operating system provides the appropriate communications protocols to establish communication links with the network 607. Any number and type of machines may be in communication with the computers.

The computer implemented method and system 600 disclosed herein are not limited to a particular computer system platform, processor, operating system, or network. In an embodiment, one or more aspects of the computer implemented method and system 600 disclosed herein are distributed among one or more computer systems, for example, servers configured to provide one or more services to one or more client computers, or to perform a complete task in a distributed system. For example, one or more aspects of the computer implemented method and system 600 disclosed herein are performed on a client-server system that comprises components distributed among one or more server systems that perform multiple functions according to various embodiments. These components comprise, for example, executable, intermediate, or interpreted code, which communicate over the network 607 using a communication protocol. The computer implemented method and system 600 disclosed herein are not limited to be executable on any particular system or group of systems, and are not limited to any particular distributed architecture, network, or communication protocol.

The foregoing examples have been provided merely for the purpose of explanation and are in no way to be construed as limiting of the computer implemented method and system 600 disclosed herein. While the computer implemented method and system 600 have been described with reference to various embodiments, it is understood that the words, which have been used herein, are words of description and illustration, rather than words of limitation. Further, although the computer implemented method and system 600 have been described herein with reference to particular means, materials, and embodiments, the computer implemented method and system 600 are not intended to be limited to the particulars disclosed herein; rather, the computer implemented method and system 600 extend to all functionally equivalent structures, methods and uses, such as are within the scope of the appended claims. Those skilled in the art, having the benefit of the teachings of this specification, may effect numerous modifications thereto and changes may be made without departing from the scope and spirit of the computer implemented method and system 600 disclosed herein in their aspects.

I claim:

1. A computer implemented method for overlaying user media content on content data streams and synchronizing the content data streams in real time with the overlaid user media content, the method employing an interactive content overlay and streaming system comprising at least one processor configured to execute computer program instructions for performing the method, the method comprising:
rendering an interactive space editor with a plurality of content panels on a graphical user interface deployed on a user device by the interactive content overlay and streaming system, wherein the content panels comprise links to the content data streams from a plurality of content sources;
receiving a selection of one or more of the content data streams to be rendered on the content panels of the interactive space editor from the user device by the interactive content overlay and streaming system;
recording the user media content on the user device using a media and event recorder of the user device while streaming the one or more of the content data streams on the graphical user interface, by the interactive content overlay and streaming system, when a request to record the user media content is received from the user device, wherein the user media content being recorded is dynamically received by the interactive content overlay and streaming system from the user device;
overlaying the user media content being recorded on the one or more of the content data streams being streamed by the interactive content overlay and streaming system;
recording content panel events and synchronization data on the user device by the interactive content overlay and streaming system during the recording of the user media content;
receiving the recorded user media content, the recorded content panel events, and the recorded synchronization data from the user device by the interactive content overlay and streaming system, when a request for terminating the recording of the user media content is received from the user device;
generating a content media object by processing the received user media content by the interactive content overlay and streaming system for providing access of the processed user media content and the one or more of the content data streams through the generated content media object to viewer devices by the interactive content overlay and streaming system;
overlaying the processed user media content and an interaction panel on the one or more of the content data streams on the graphical user interface deployed on each of the viewer devices by the interactive content overlay and streaming system, when the generated content media object is accessed by the viewer devices via the graphical user interface deployed on the each of the viewer devices;
streaming the one or more of the content data streams and the overlaid user media content, and displaying comments entered in the interaction panel from the viewer devices via the graphical user interface deployed on the each of the viewer devices by the interactive content overlay and streaming system; and
synchronizing the one or more of the content data streams being streamed in real time with the overlaid user media content being streamed by the interactive content overlay and streaming system using the received content panel events and the received synchronization data.

2. The computer implemented method of claim 1, wherein the content panel events comprise layout changes in the content panels on the graphical user interface, changes in an orientation of the user media content, and buffering of the one or more of the content data streams being streamed during the recording of the user media content.

3. The computer implemented method of claim 1, wherein the processing of the received user media content for the generation of the content media object by the interactive content overlay and streaming system comprises creating different formats of the received user media content and generating a thumbnail of the received user media content.

4. The computer implemented method of claim 1, wherein the synchronization data comprises information on time at which the recording of the user media content is initiated, time at which each of the content panel events is recorded, and time at which the recording of the user media content is terminated.

5. The computer implemented method of claim 1, further comprising:
suspending the streaming of the overlaid user media content by the interactive content overlay and streaming system when the one or more of the content data streams being streamed are buffering; and
resuming the streaming of the overlaid user media content by the interactive content overlay and streaming system when the one or more of the content data streams being streamed have buffered for the synchronization of the one or more of the content data streams in real time with the overlaid user media content by the interactive content overlay and streaming system.

6. The computer implemented method of claim 1, further comprising simultaneously recording the user media content on the user device and overlaying the user media content being recorded on the user device and the interaction panel on a live one of the content data streams on the graphical user interface deployed on the each of the viewer devices by the interactive content overlay and streaming system.

7. The computer implemented method of claim 1, wherein the content data streams comprise videos, webpages, live cable television content, video chat content, video conferencing content, gaming content, web browsing content, video-on-demand content, social media networking content, live video content, canned video content, user generated content, message content, electronic mail content, audio content, audiovisual content, augmented reality content, three-dimensional media content, electronic commerce content, information, multimedia content, and any combination thereof.

8. A computer implemented system for overlaying user media content on content data streams and synchronizing the content data streams in real time with the overlaid user media content, the computer implemented system comprising:
a non-transitory computer readable storage medium configured to store computer program instructions defined by modules of an interactive content overlay and streaming system; and
at least one processor communicatively coupled to the non-transitory computer readable storage medium, the at least one processor configured to execute the computer program instructions defined by the modules of the interactive content overlay and streaming system, the modules of the interactive content overlay and streaming system comprising:
an interactive space editor rendering module configured to render an interactive space editor with a plurality of content panels on a graphical user interface deployed on a user device, wherein the content panels comprise links to the content data streams from a plurality of content sources;
an application programming interface module configured to receive a selection of one or more of the content data streams to be rendered on the content panels of the interactive space editor from the user device;
a media and event recorder configured to record the user media content on the user device while the one or more of the content data streams are streamed on the graphical user interface, when a request to record the user media content is received from the user device, wherein the user media content being recorded is dynamically received from the user device and stored in a server database;
a content overlay module configured to overlay the user media content being recorded on the one or more of the content data streams being streamed;
the media and event recorder further configured to record content panel events and synchronization data on the user device during the recording of the user media content;
a media processing module configured to receive the recorded user media content, the recorded content panel events, and the recorded synchronization data from the user device, when a request for terminating the recording of the user media content is received from the user device;
the media processing module further configured to generate a content media object by processing the received user media content for providing access of the processed user media content and the one or more of the content data streams through the generated content media object to viewer devices;
the content overlay module further configured to overlay the processed user media content and an interaction panel on the one or more of the content data streams on the graphical user interface deployed on each of the viewer devices when the generated content media object is accessed by the viewer devices via the graphical user interface deployed on the each of the viewer devices;
a playback manager configured to stream the one or more of the content data streams and the overlaid user media content and display comments entered in the interaction panel from the viewer devices via the graphical user interface deployed on the each of the viewer devices; and
a playback synchronizer configured to synchronize the one or more of the content data streams being streamed in real time with the overlaid user media content being streamed using the received content panel events and the received synchronization data.

9. The computer implemented system of claim 8, wherein the content panel events comprise layout changes in the content panels on the graphical user interface, changes in an orientation of the user media content, and buffering of the one or more of the content data streams being streamed during the recording of the user media content.

10. The computer implemented system of claim 8, wherein the media processing module is further configured to create different formats of the received user media content and generate a thumbnail of the received user media content during the processing of the received user media content to generate the content media object.

11. The computer implemented system of claim 8, wherein the synchronization data comprises information on time at which the recording of the user media content is initiated, time at which each of the content panel events is recorded, and time at which the recording of the user media content is terminated.

12. The computer implemented system of claim 8, wherein the playback synchronizer is further configured to suspend the streaming of the overlaid user media content when the one or more of the content data streams being streamed are buffering, and wherein the playback synchronizer is further configured to resume the streaming of the overlaid user media content when the one or more of the content data streams being streamed have buffered for the synchronization of the one or more of the content data streams in real time with the overlaid user media content.

13. The computer implemented system of claim 8, wherein the media and event recorder is further configured to record the user media content on the user device, and wherein the content overlay module is further configured to simultaneously overlay the user media content being recorded on the user device and the interaction panel on a live one of the content data streams on the graphical user interface deployed on the each of the viewer devices.

14. The computer implemented system of claim 8, wherein the content data streams comprise videos, webpages, live cable television content, video chat content, video conferencing content, gaming content, web browsing content, video-on-demand content, social media networking content, live video content, canned video content, user generated content, message content, electronic mail content, audio content, audiovisual content, augmented reality content, three-dimensional media content, electronic commerce content, information, multimedia content, and any combination thereof.

15. A non-transitory computer readable storage medium having embodied thereon, computer program codes comprising instructions executable by at least one processor for overlaying user media content on content data streams and synchronizing the content data streams in real time with the overlaid user media content, the computer program codes comprising:
a first computer program code for rendering an interactive space editor with a plurality of content panels on a graphical user interface deployed on a user device, wherein the content panels comprise links to the content data streams from a plurality of content sources;
a second computer program code for receiving a selection of one or more of the content data streams to be rendered on the content panels of the interactive space editor from the user device;
a third computer program code for recording the user media content on the user device using a media and event recorder of the user device while streaming the one or more of the content data streams on the graphical user interface, when a request to record the user media content is received from the user device, wherein the user media content being recorded is dynamically received from the user device and stored in a server database;
a fourth computer program code for overlaying the user media content being recorded on the one or more of the content data streams being streamed;
a fifth computer program code for recording content panel events and synchronization data on the user device during the recording of the user media content;
a sixth computer program code for receiving the recorded user media content, the recorded content panel events, and the recorded synchronization data from the user device, when a request for terminating the recording of the user media content is received from the user device;
a seventh computer program code for generating a content media object by processing the received user media content for providing access of the processed user media content and the one or more of the content data streams through the generated content media object to viewer devices;
an eighth computer program code for overlaying the processed user media content and an interaction panel on the one or more of the content data streams on the graphical user interface deployed on each of the viewer devices when the generated content media object is accessed by the viewer devices via the graphical user interface deployed on the each of the viewer devices;
a ninth computer program code for streaming the one or more of the content data streams and the overlaid user media content, and displaying comments entered in the interaction panel from the viewer devices via the graphical user interface deployed on the each of the viewer devices; and
a tenth computer program code for synchronizing the one or more of the content data streams being streamed in real time with the overlaid user media content being streamed using the received content panel events and the received synchronization data.

16. The non-transitory computer readable storage medium of claim 15, wherein the tenth computer program code further comprises:
an eleventh computer program code for suspending the streaming of the overlaid user media content when the one or more of the content data streams being streamed are buffering; and
a twelfth computer program code for resuming the streaming of the overlaid user media content when the one or more of the content data streams being streamed have buffered for the synchronization of the one or more of the content data streams in real time with the overlaid user media content.

17. The non-transitory computer readable storage medium of claim 15, wherein the content panel events comprise layout changes in the content panels on the graphical user interface, changes in an orientation of the user media content, and buffering of the one or more of the content data streams being streamed during the recording of the user media content.

18. The non-transitory computer readable storage medium of claim 15, wherein the synchronization data comprises information on time at which the recording of the user media content is initiated, time at which each of the content panel events is recorded, and time at which the recording of the user media content is terminated.

19. The non-transitory computer readable storage medium of claim 15, wherein the content data streams comprise videos, webpages, live cable television content, video chat content, video conferencing content, gaming content, web browsing content, video-on-demand content, social media networking content, live video content, canned video content, user generated content, message content, electronic mail content, audio content, audiovisual content, augmented reality content, three-dimensional media content, electronic commerce content, information, multimedia content, and any combination thereof.
